(19) United States
(12) Patent Application Publication
(10) Pub. No.: US 2018/0201838 A1
(43) Pub. Date: Jul. 19, 2018

(54) FLAME-RETARDANT POLYOLEFIN SYSTEMS

(71) Applicant: BASF SE, Ludwigshafen (DE)

(72) Inventors: Stephen Mark Andrews, New Fairfield, CT (US); Thomas Friend Thompson, Highland Mills, NY (US)

(21) Appl. No.: 15/743,251

(22) PCT Filed: Jul. 20, 2016
(86) PCT No.: PCT/US2016/043088

§ 371 Date: Jan. 9, 2018

Related U.S. Application Data
(60) Provisional application No. 62/194,503, filed on Jul. 20, 2015.

(51) Int. Cl. C09K 21/12; C08K 5/5357; C08K 5/521; C08K 5/3492; C08K 5/524; C08K 5/134; C08L 23/12; C08K 5/098

(52) U.S. Cl. CPC C09K 21/12; C08K 5/5357; C08K 5/521; C08K 5/34926; C08L 2201/02; C08K 5/134; C08L 23/12; C08K 5/098; C08K 2201/014; C08K 5/524

(57) ABSTRACT

Disclosed in certain embodiments are non-halogenated flame-retardant polyolefin articles. The articles include polyolefin substrates having additives contained therein.

### CROSS-REFERENCE TO RELATED APPLICATIONS

This application claims priority to U.S. Provisional Application No. 62/194,503, filed Jul. 20, 2015, the contents of which are incorporated by reference in its entirety into the present disclosure.

### FIELD OF THE INVENTION

The present invention relates to flame-retardant materials and, more specifically, to flame-retardant polyolefin systems.

### BACKGROUND

Flame-retardant polyolefin systems utilize a polyolefin substrate that incorporates various additives. Systems for producing thick polypropylene articles typically utilize reinforcing fillers. However, these systems provide only modest at best flame-retardancy, as determined by the UL94 vertical burn (“VB”) test, and can adversely affect mechanical properties of the articles due to high filler loading.

Halogenated flame-retardant systems have been used in conjunction with polypropylene, however these systems typically require a synergist such as antimony oxide, which often contains trace amounts of arsenic. Some halogenated aromatic flame-retardants are unstable to solar radiation, which can lead to discoloration. Moreover, halogenated flame-retardants must often be used at high loadings (e.g., greater than 10 wt %), which is costly and may compromise mechanical properties of the manufactured articles.

Organic salts, such as ammonium polyphosphate, inorganic minerals, such as magnesium dihydroxide or aluminum trihydrate, have also been used in flame-retardant polyolefin systems. At flame temperatures, such materials are presumed to produce offgases, such as ammonia or water vapor, which dilute the oxygen content near the polymer-flame interface. However, these materials are often used at extremely high levels (30 wt % to 60 wt %) and result in an undesirable visual appearance and a deleterious effect on polymer tensile and impact properties.

It would be desirable to formulate an effective flame-retardant system for thick polypropylene articles that is free of or substantially free of heavy metals and halogen species. Moreover, it would be desirable for such a system to meet or exceed required levels of light stability, processing stability, flame-retardancy, and mechanical properties for various applications.

### SUMMARY OF THE INVENTION

Certain embodiments of the present invention are directed to a flame-retardant article having a polyolefin substrate with additives incorporated therein, the additives including: an organophosphorus compound including a phosphonate ester, a phosphate ester, or a combination thereof; and a synergist including an N-alkoxy hindered amine. A performance rating of the article from a UL-94 vertical burn (VB) test achieves a V-0 rating when the article is in a form of a 125 mil injection molded bar.

Certain embodiments are directed to a flame-retardant article having a polyolefin substrate with additives incorporated therein, the additives including: an organophosphorus compound including a phosphonate ester, a phosphate ester, or a combination thereof; and a synergist including an N-alkoxy hindered amine. In certain embodiments, the flame-retardant article is a building material.

Certain embodiments are directed to a flame-retardant composition, the composition including: a polyolefin; a phosphonate ester having a formula of:

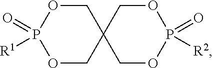

wherein the variables are disclosed herein; a synergist having a formula of:

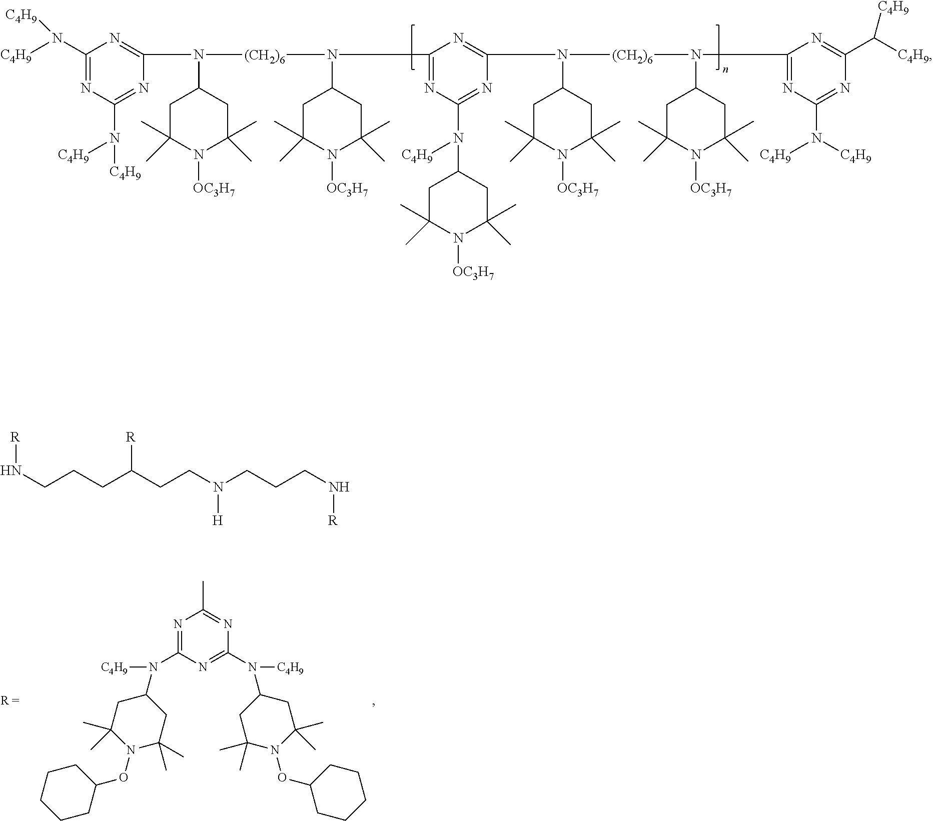

or
wherein n is an integer from 1 to 15, the synergist being present in an amount from about 0.1 wt % to about 3 wt %; an antioxidant; and an acid scavenger.

For the purpose of the present disclosure, the term “alkyl” as used by itself or as part of another group refers to a straight- or branched-chain aliphatic hydrocarbon containing one to twelve carbon atoms (i.e., C₁₋₁₂ alkyl) or the number of carbon atoms designated (i.e., a C₁ alkyl such as methyl, a C₂ alkyl such as ethyl, a C₃ alkyl such as propyl or isopropyl, etc.). In one embodiment, the alkyl group is chosen from a straight chain C₁₋₁₀ alkyl group. In another embodiment, the alkyl group is chosen from a branched chain C₁₋₁₀ alkyl group. In another embodiment, the alkyl group is chosen from a straight chain C₁₋₆ alkyl group. In another embodiment, the alkyl group is chosen from a branched chain C₁₋₆ alkyl group. In another embodiment, the alkyl group is chosen from a straight chain C₁₋₄ alkyl group. In another embodiment, the alkyl group is chosen from a branched chain C₁₋₄ alkyl group. In another embodiment, the alkyl group is chosen from a straight or branched chain C₂₋₄ alkyl group. Non-limiting exemplary C₁₋₁₀ alkyl groups include methyl, ethyl, propyl, isopropyl, butyl, sec-butyl, tert-butyl, iso-butyl, 3-pentyl, hexyl, heptyl, octyl, nonyl, decyl, and the like. Non-limiting exemplary C₁₋₄ alkyl groups include methyl, ethyl, propyl, isopropyl, butyl, sec-butyl, tert-butyl, and iso-butyl.

For the purpose of the present disclosure, the term “optionally substituted alkyl” as used by itself or as part of another group means that the alkyl as defined above is either unsubstituted or substituted with one, two, or three substituents independently chosen from nitro, haloalkoxy, aryloxy, aralkyloxy, alkylthio, sulfonamido, alkylcarbonyl, arylcarbonyl, alkylsulfonyl, arylsulfonyl, ureido, guanidino, carboxy, carboxyalkyl, cycloalkyl, and the like. In one embodiment, the optionally substituted alkyl is substituted with two substituents. In another embodiment, the optionally substituted alkyl is substituted with one substituent. Non-limiting exemplary optionally substituted alkyl groups include —CH₂CH₂NO₂, —CH₂CH₂CO₂H, —CH₂CH₂SO₂CH₃, —CH₂CH₂COPh, —CH₂C₆H₁₁, and the like.

For the purpose of the present disclosure, the term “alkoxy” as used by itself or as part of another group refers to an optionally substituted alkyl, optionally substituted cycloalkyl, optionally substituted alkenyl, optionally substituted cycloalkenyl, optionally substituted alkynyl, or optionally substituted alkynyl attached to a terminal oxygen atom. In one embodiment, the alkoxy group is chosen from a C₁₋₄ alkoxy group. In another embodiment, the alkoxy group is chosen from a C₁₋₄ alkyl attached to a terminal oxygen atom, e.g., methoxy, ethoxy, and tert-butoxy. Alkoxy groups may also include groups such as cycloalkoxy, cyclohexyloxy, methoxy, propoxy, or 2-methyl-2-hydroxypropoxy.

For the purpose of the present disclosure, the term “alkenyl” as used by itself or as part of another group refers to an alkyl group as defined above containing one, two or three carbon-to-carbon double bonds. In one embodiment, the alkenyl group is chosen from a C₂₋₆ alkenyl group. In another embodiment, the alkenyl group is chosen from a C₂₋₄ alkenyl group. Non-limiting exemplary alkenyl groups include ethenyl, propenyl, isopropenyl, butenyl, sec-butenyl, pentenyl, and hexenyl.

For the purpose of the present disclosure, the term “optionally substituted alkenyl” as used herein by itself or as part of another group means the alkenyl as defined above is either unsubstituted or substituted with one, two or three substituents independently chosen from halo, nitro, cyano, hydroxy, amino, alkylamino, dialkylamino, haloalkyl, hydroxyalkyl, alkoxy, haloalkoxy, aryloxy, aralkyloxy, alkylthio, carboxamido, sulfonamido, alkylcarbonyl, arylcarbonyl, alkyl sulfonyl, arylsulfonyl, ureido, guanidino, carboxy, carboxyalkyl, alkyl, cycloalkyl, alkenyl, alkynyl, aryl, heteroaryl, or heterocyclo.

For the purpose of the present disclosure, the term “alkynyl” as used by itself or as part of another group refers to an alkyl group as defined above containing one to three carbon-to-carbon triple bonds. In one embodiment, the alkynyl has one carbon-to-carbon triple bond. In one embodiment, the alkynyl group is chosen from a C₂₋₆ alkynyl group. In another embodiment, the alkynyl group is chosen from a C₂₋₄ alkynyl group. Non-limiting exemplary alkynyl groups include ethynyl, propynyl, butynyl, 2-butynyl, pentynyl, and hexynyl groups.

For the purpose of the present disclosure, the term “optionally substituted alkynyl” as used herein by itself or as part of another group means the alkynyl as defined above is either unsubstituted or substituted with one, two or three substituents independently chosen from halo, nitro, cyano, hydroxy, amino, alkylamino, dialkylamino, haloalkyl, hydroxyalkyl, alkoxy, haloalkoxy, aryloxy, aralkyloxy, alkylthio, carboxamido, sulfonamido, alkylcarbonyl, arylcarbonyl, alkyl sulfonyl, arylsulfonyl, ureido, guanidino, carboxy, carboxyalkyl, alkyl, cycloalkyl, alkenyl, alkynyl, aryl, heteroaryl, or heterocyclo.

For the purpose of the present disclosure, the term “cycloalkyl” as used by itself or as part of another group refers to saturated and partially unsaturated (containing one or two double bonds) cyclic aliphatic hydrocarbons containing one to three rings having from three to twelve carbon atoms (i.e., C₃₋₁₂ cycloalkyl) or the number of carbons designated. In one embodiment, the cycloalkyl group has two rings. In one embodiment, the cycloalkyl group has one ring. In another embodiment, the cycloalkyl group is chosen from a C₃₋₈ cycloalkyl group. In another embodiment, the cycloalkyl group is chosen from a C₃₋₆ cycloalkyl group. Non-limiting exemplary cycloalkyl groups include cyclopropyl, cyclobutyl, cyclopentyl, cyclohexyl, cycloheptyl, cyclooctyl, norbornyl, decalin, adamantyl, cyclohexenyl, and the like.

For the purpose of the present disclosure, the term “optionally substituted cycloalkyl” as used by itself or as part of another group means that the cycloalkyl as defined above is either unsubstituted or substituted with one, two, or three substituents independently chosen from halo, nitro, cyano, hydroxy, amino, alkylamino, dialkylamino, haloalkyl, hydroxyalkyl, alkoxy, haloalkoxy, aryloxy, aralkyloxy, alkylthio, carboxamido, sulfonamido, alkylcarbonyl, arylcarbonyl, alkyl sulfonyl, aryl sulfonyl, ureido, guanidino, carboxy, carboxyalkyl, alkyl, cycloalkyl, alkenyl, alkynyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, and (heteroaryl)alkyl. In one embodiment, the optionally substituted cycloalkyl is substituted with two substituents. In another embodiment, the optionally substituted cycloalkyl is substituted with one substituent. Non-limiting exemplary optionally substituted cycloalkyl groups include:

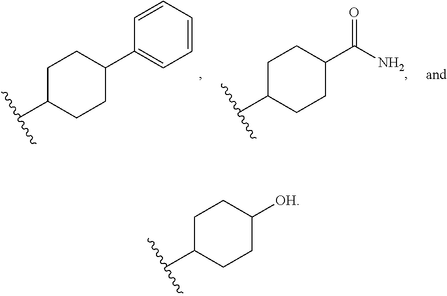 [SMILES: *C1CCC(c2ccccc2)CC1 ; *C1CCC(C(N)=O)CC1 ; "and" ; *C1CCC(O)CC1]

For the purpose of the present disclosure, the term “cycloalkenyl” as used by itself or part of another group refers to a partially unsaturated cycloalkyl group as defined above. In one embodiment, the cycloalkenyl has one carbon-to-carbon double bond. In another embodiment, the cycloalkenyl group is chosen from a C₄₋₈ cycloalkenyl group. Exemplary cycloalkenyl groups include cyclopentenyl, cyclohexenyl, and the like.

For the purpose of the present disclosure, the term “optionally substituted cycloalkenyl” as used by itself or as part of another group means that the cycloalkenyl as defined above is either unsubstituted or substituted with one, two, or three substituents independently chosen from halo, nitro, cyano, hydroxy, amino, alkylamino, dialkylamino, haloalkyl, monohydroxyalkyl, dihydroxyalkyl, alkoxy, haloalkoxy, aryloxy, aralkyloxy, alkylthio, carboxamido, sulfonamido, alkylcarbonyl, arylcarbonyl, alkyl sulfonyl, arylsulfonyl, ureido, guanidino, carboxy, carboxyalkyl, alkyl, cycloalkyl, alkenyl, alkynyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, and (heteroaryl)alkyl. In one embodiment, the optionally substituted cycloalkenyl is substituted with two substituents. In another embodiment, the optionally substituted cycloalkenyl is substituted with one substituent. In another embodiment, the cycloalkenyl is unsubstituted.

For the purpose of the present disclosure, the term “haloalkyl” as used by itself or as part of another group refers to an alkyl group substituted by one or more fluorine, chlorine, bromine and/or iodine atoms. In one embodiment, the alkyl group is substituted by one, two, or three fluorine and/or chlorine atoms. In another embodiment, the haloalkyl group is chosen from a C₁₋₄ haloalkyl group. Non-limiting exemplary haloalkyl groups include fluoromethyl, difluoromethyl, trifluoromethyl, pentafluoroethyl, 1,1-difluoroethyl, 2,2-difluoroethyl, 2,2,2-trifluoroethyl, 3,3,3-trifluoropropyl, 4,4,4-trifluorobutyl, and trichloromethyl groups.

For the purpose of the present disclosure, the term “hydroxyalkyl” as used by itself or as part of another group refers to an alkyl group substituted with one or more, e.g., one, two, or three, hydroxy groups. In one embodiment, the hydroxyalkyl group is a monohydroxyalkyl group, i.e., substituted with one hydroxy group. In another embodiment, the hydroxyalkyl group is a dihydroxyalkyl group, i.e., substituted with two hydroxy groups. In another embodiment, the hydroxyalkyl group is chosen from a C₁₋₄ hydroxyalkyl group. Non-limiting exemplary hydroxyalkyl groups include hydroxymethyl, hydroxyethyl, hydroxypropyl and hydroxybutyl groups, such as 1-hydroxyethyl, 2-hydroxyethyl, 1,2-dihydroxyethyl, 2-hydroxypropyl, 3-hydroxypropyl, 3-hydroxybutyl, 4-hydroxybutyl, 2-hydroxy-1-methylpropyl, and 1,3-dihydroxyprop-2-yl.

For the purpose of the present disclosure, the term “alkoxyalkyl” as used by itself or as part of another group refers to an alkyl group substituted with an alkoxy group. Non-limiting exemplary alkoxyalkyl groups include methoxymethyl, methoxyethyl, methoxypropyl, methoxybutyl, ethoxymethyl, ethoxyethyl, ethoxypropyl, ethoxybutyl, propoxymethyl, iso-propoxymethyl, propoxyethyl, propoxypropyl, butoxymethyl, tert-butoxymethyl, isobutoxymethyl, sec-butoxymethyl, and pentyloxymethyl.

For the purpose of the present disclosure, the term “haloalkoxy” as used by itself or as part of another group refers to a haloalkyl attached to a terminal oxygen atom. Non-limiting exemplary haloalkoxy groups include fluoromethoxy, difluoromethoxy, trifluoromethoxy, and 2,2,2-trifluoroethoxy.

For the purpose of the present disclosure, the term “aryl” as used by itself or as part of another group refers to a monocyclic or bicyclic aromatic ring system having from six to fourteen carbon atoms (i.e., C₆₋₁₄ aryl). Non-limiting exemplary aryl groups include phenyl (abbreviated as “Ph”), naphthyl, phenanthryl, anthracyl, indenyl, azulenyl, biphenyl, biphenylenyl, and fluorenyl groups. In one embodiment, the aryl group is chosen from phenyl or naphthyl.

For the purpose of the present disclosure, the term “optionally substituted aryl” as used herein by itself or as part of another group means that the aryl as defined above is either unsubstituted or substituted with one to five substituents independently chosen from halo, nitro, cyano, hydroxy, amino, alkylamino, dialkylamino, haloalkyl, hydroxyalkyl, alkoxy, haloalkoxy, aryloxy, aralkyloxy, alkylthio, carboxamido, sulfonamido, alkylcarbonyl, arylcarbonyl, alkyl sulfonyl, arylsulfonyl, ureido, guanidino, carboxy, carboxyalkyl, alkyl, cycloalkyl, alkenyl, alkynyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, or (heteroaryl)alkyl. In one embodiment, the optionally substituted aryl is an optionally substituted phenyl. In one embodiment, the optionally substituted phenyl has four substituents. In another embodiment, the optionally substituted phenyl has three substituents. In another embodiment, the optionally substituted phenyl has two substituents. In another embodiment, the optionally substituted phenyl has one substituent. Non-limiting exemplary substituted aryl groups include 2-methylphenyl, 2-methoxyphenyl, 2-fluorophenyl, 2-chlorophenyl, 2-bromophenyl, 3-methylphenyl, 3-methoxyphenyl, 3-fluorophenyl, 3-chlorophenyl, 4-methylphenyl, 4-ethylphenyl, 4-methoxyphenyl, 4-fluorophenyl, 4-chlorophenyl, 2,6-di-fluorophenyl, 2,6-di-chlorophenyl, 2-methyl, 3-methoxyphenyl, 2-ethyl, 3-methoxyphenyl, 3,4-di-methoxyphenyl, 3,5-di-fluorophenyl 3,5-di-methylphenyl, 3,5-dimethoxy, 4-methylphenyl, 2-fluoro-3-chlorophenyl, and 3-chloro-4-fluorophenyl. The term optionally substituted aryl is meant to include groups having fused optionally substituted cycloalkyl and fused optionally substituted heterocyclo rings. Examples include:

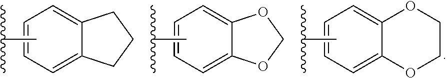

For the purpose of the present disclosure, the term “aryloxy” as used by itself or as part of another group refers to an optionally substituted aryl attached to a terminal oxygen atom. A non-limiting exemplary aryloxy group is PhO—.

For the purpose of the present disclosure, the term “aralkyloxy” as used by itself or as part of another group refers to an aralkyl group attached to a terminal oxygen atom. A non-limiting exemplary aralkyloxy group is PhCH₂O—.

For the purpose of the present disclosure, the term “heteroaryl” refers to monocyclic and bicyclic aromatic ring systems having 5 to 14 ring atoms (i.e., C₅₋₁₄ heteroaryl) and 1, 2, 3, or 4 heteroatoms independently chosen from oxygen, nitrogen and sulfur. In one embodiment, the heteroaryl has three heteroatoms. In another embodiment, the heteroaryl has two heteroatoms. In another embodiment, the heteroaryl has one heteroatom. In one embodiment, the heteroaryl is a C₅ heteroaryl. In another embodiment, the heteroaryl is a C₆ heteroaryl. Non-limiting exemplary heteroaryl groups include thienyl, benzo[b]thienyl, naphtho[2,3-b]thienyl, thianthrenyl, furyl, benzofuryl, pyranyl, isobenzofuranyl, benzooxazonyl, chromenyl, xanthenyl, 2H-pyrrolyl, pyrrolyl, imidazolyl, pyrazolyl, pyridyl, pyrazinyl, pyrimidinyl, pyridazinyl, isoindolyl, 3H-indolyl, indolyl, indazolyl, purinyl, isoquinolyl, quinolyl, phthalazinyl, naphthyridinyl, cinnolinyl, quinazolinyl, pteridinyl, 4aH-carbazolyl, carbazolyl, β-carbolinyl, phenanthridinyl, acridinyl, pyrimidinyl, phenanthrolinyl, phenazinyl, thiazolyl, isothiazolyl, phenothiazolyl, isoxazolyl, furazanyl, and phenoxazinyl. In one embodiment, the heteroaryl is chosen from thienyl (e.g., thien-2-yl and thien-3-yl), furyl (e.g., 2-furyl and 3-furyl), pyrrolyl (e.g., 1H-pyrrol-2-yl and 1H-pyrrol-3-yl), imidazolyl (e.g., 2H-imidazol-2-yl and 2H-imidazol-4-yl), pyrazolyl (e.g., 1H-pyrazol-3-yl, 1H-pyrazol-4-yl, and 1H-pyrazol-5-yl), pyridyl (e.g., pyridin-2-yl, pyridin-3-yl, and pyridin-4-yl), pyrimidinyl (e.g., pyrimidin-2-yl, pyrimidin-4-yl, pyrimidin-5-yl, and pyrimidin-5-yl), thiazolyl (e.g., thiazol-2-yl, thiazol-4-yl, and thiazol-5-yl), isothiazolyl (e.g., isothiazol-3-yl, isothiazol-4-yl, and isothiazol-5-yl), oxazolyl (e.g., oxazol-2-yl, oxazol-4-yl, and oxazol-5-yl) and isoxazolyl (e.g., isoxazol-3-yl, isoxazol-4-yl, and isoxazol-5-yl). The term “heteroaryl” is also meant to include possible N-oxides. Exemplary N-oxides include pyridyl N-oxide, and the like.

For the purpose of the present disclosure, the term “optionally substituted heteroaryl” as used by itself or as part of another group means that the heteroaryl as defined above is either unsubstituted or substituted with one to four substituents, e.g., one or two substituents, independently chosen from halo, nitro, cyano, hydroxy, amino, alkylamino, dialkylamino, haloalkyl, hydroxyalkyl, alkoxy, haloalkoxy, aryloxy, aralkyloxy, alkylthio, carboxamido, sulfonamido, alkylcarbonyl, arylcarbonyl, alkylsulfonyl, arylsulfonyl, ureido, guanidino, carboxy, carboxyalkyl, alkyl, cycloalkyl, alkenyl, alkynyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, and (heteroaryl)alkyl. In one embodiment, the optionally substituted heteroaryl has one substituent. In one embodiment, the optionally substituted is an optionally substituted pyridyl, i.e., 2-, 3-, or 4-pyridyl. Any available carbon or nitrogen atom can be substituted. In another embodiment, the optionally substituted heteroaryl is an optionally substituted indole.

For the purpose of the present disclosure, the term “heterocycle” or “heterocyclo” as used by itself or as part of another group refers to saturated and partially unsaturated (e.g., containing one or two double bonds) cyclic groups containing one, two, or three rings having from three to fourteen ring members (i.e., a 3- to 14-membered heterocyclo) and at least one heteroatom. Each heteroatom is independently selected from the group consisting of oxygen, sulfur, including sulfoxide and sulfone, and/or nitrogen atoms, which can be quaternized. The term “heterocyclo” is meant to include cyclic ureido groups such as 2-imidazolidinone and cyclic amide groups such as β-lactam, γ-lactam, δ-lactam and ε-lactam. The term “heterocyclo” is also meant to include groups having fused optionally substituted aryl groups, e.g., indolinyl. In one embodiment, the heterocyclo group is chosen from a 5- or 6-membered cyclic group containing one ring and one or two oxygen and/or nitrogen atoms. The heterocyclo can be optionally linked to the rest of the molecule through a carbon or nitrogen atom. Non-limiting exemplary heterocyclo groups include 2-imidazolidinone, piperidinyl, morpholinyl, piperazinyl, pyrrolidinyl, and indolinyl.

For the purpose of the present disclosure, the term “optionally substituted heterocyclo” as used herein by itself or part of another group means the heterocyclo as defined above is either unsubstituted or substituted with one to four substituents independently selected from halo, nitro, cyano, hydroxy, amino, alkylamino, dialkylamino, haloalkyl, hydroxyalkyl, alkoxy, haloalkoxy, aryloxy, aralkyloxy, alkylthio, carboxamido, sulfonamido, alkylcarbonyl, arylcarbonyl, alkyl sulfonyl, arylsulfonyl, ureido, guanidino, carboxy, carboxyalkyl, alkyl, cycloalkyl, alkenyl, alkynyl, aryl, heteroaryl, heterocyclo, alkoxyalkyl, (amino)alkyl, hydroxyalkylamino, (alkylamino)alkyl, (dialkylamino)alkyl, (cyano)alkyl, (carboxamido)alkyl, mercaptoalkyl, (heterocyclo)alkyl, (heteroaryl)alkyl, and the like. Substitution may occur on any available carbon or nitrogen atom, and may form a spirocycle. Non-limiting exemplary optionally substituted heterocyclo groups include:

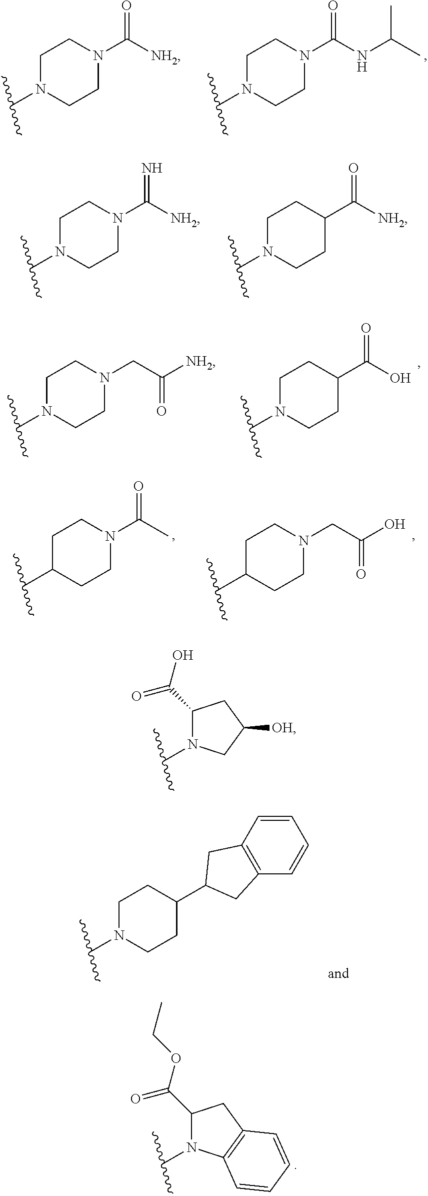

For the purpose of the present disclosure, the term “amino” as used by itself or as part of another group refers to —NH₂.

For the purpose of the present disclosure, the term “alkylamino” as used by itself or as part of another group refers to —NHR¹⁵, wherein R¹⁵ is alkyl.

For the purpose of the present disclosure, the term “dialkylamino” as used by itself or as part of another group refers to —NR^{16a}R^{16b}, wherein R^{16a} and R^{16b} are each independently alkyl or R^{16a} and R^{16b} are taken together to form a 3- to 8-membered optionally substituted heterocyclo.

For the purpose of the present disclosure, the term “hydroxyalkylamino” as used by itself or as part of another group refers to —NHR¹⁷, wherein R¹⁷ is hydroxyalkyl.

For the purpose of the present disclosure, the term “(amino)alkyl” as used by itself or as part of another group refers to an alkyl group substituted with an amino group. Non-limiting exemplary amino alkyl groups include —CH₂CH₂NH₂, —CH₂CH₂CH₂NH₂, —CH₂CH₂CH₂CH₂NH₂, and the like.

For the purpose of the present disclosure, the term “(alkylamino)alkyl” as used by itself or as part of another group refers alkyl group substituted an alkylamino group. A non-limiting exemplary (alkylamino)alkyl group is —CH₂CH₂N(H)CH₃.

For the purpose of the present disclosure, the term “(dialkylamino)alkyl” as used by itself or as part of another group refers to an alkyl group substituted by a dialkylamino group. A non-limiting exemplary (dialkylamino)alkyl group is —CH₂CH₂N(CH₃)₂.

For the purpose of the present disclosure, the term “(cyano)alkyl” as used by itself or as part of another group refers to an alkyl group substituted with one or more cyano, e.g., —CN, groups. Non-limiting exemplary (cyano)alkyl groups include —CH₂CH₂CN, —CH₂CH₂CH₂CN, and —CH₂CH₂CH₂CH₂CN.

For the purpose of the present disclosure, the term “carboxamido” as used by itself or as part of another group refers to a radical of formula —C(═O)NR^{24a}R^{24b}, wherein R^{24a} and R^{24b} are each independently hydrogen, optionally substituted alkyl, optionally substituted aryl, or optionally substituted heteroaryl, or R^{24a} and R^{24b} taken together with the nitrogen to which they are attached from a 3- to 8-membered heterocyclo group. In one embodiment, R^{24a} and R^{24b} are each independently hydrogen or optionally substituted alkyl. Non-limiting exemplary carboxamido groups include —CONH₂, —CON(H)CH₃, —CON(CH₃)₂, and —CON(H)Ph.

For the purpose of the present disclosure, the term “(carboxamido)alkyl” as used by itself or as part of another group refers to an alkyl group with a carboxamido group. Non-limiting exemplary (carboxamido)alkyl groups include —CH₂CONH₂, —C(H)CH₃—CONH₂, and —CH₂CON(H)CH₃.

For the purpose of the present disclosure, the term “sulfonamido” as used by itself or as part of another group refers to a radical of the formula —SO₂NR^{23a}R^{23b}, wherein R^{23a} and R^{23b} are each independently hydrogen, optionally substituted alkyl, or optionally substituted aryl, or R^{23a} and R^{23b} taken together with the nitrogen to which they are attached from a 3- to 8-membered heterocyclo group. Non-limiting exemplary sulfonamido groups include —SO₂NH₂, —SO₂N(H)CH₃, and —SO₂N(H)Ph.

For the purpose of the present disclosure, the term “alkylcarbonyl” as used by itself or as part of another group refers to a carbonyl group, i.e., —C(═O)—, substituted by an alkyl group. A non-limiting exemplary alkylcarbonyl group is —COCH₃.

For the purpose of the present disclosure, the term “arylcarbonyl” as used by itself or as part of another group refers to a carbonyl group, i.e., —C(═O)—, substituted by an optionally substituted aryl group. A non-limiting exemplary arylcarbonyl group is —COPh.

For the purpose of the present disclosure, the term “alkylsulfonyl” as used by itself or as part of another group refers to a sulfonyl group, i.e., —SO₂—, substituted by any of the above-mentioned optionally substituted alkyl groups. A non-limiting exemplary alkylsulfonyl group is —SO₂CH₃.

For the purpose of the present disclosure, the term “arylsulfonyl” as used by itself or as part of another group refers to a sulfonyl group, i.e., —SO₂—, substituted by any of the above-mentioned optionally substituted aryl groups. A non-limiting exemplary arylsulfonyl group is —SO₂Ph.

For the purpose of the present disclosure, the term “mercaptoalkyl” as used by itself or as part of another group refers to any of the above-mentioned alkyl groups substituted by a —SH group.

For the purpose of the present disclosure, the term “carboxy” as used by itself or as part of another group refers to a radical of the formula —COOH.

For the purpose of the present disclosure, the term “carboxyalkyl” as used by itself or as part of another group refers to any of the above-mentioned alkyl groups substituted with a —COOH. A non-limiting exemplary carboxyalkyl group is —CH₂CO₂H.

For the purpose of the present disclosure, the term “aralkyl” as used by itself or as part of another group refers to an alkyl group substituted with one, two, or three optionally substituted aryl groups. In one embodiment, the aralkyl group is a C₁₋₄ alkyl substituted with one optionally substituted aryl group. Non-limiting exemplary aralkyl groups include benzyl, phenethyl, —CHPh₂, and —CH(4-FPh)₂.

For the purpose of the present disclosure, the term “ureido” as used by itself or as part of another group refers to a radical of the formula NR^{22a}C(═O)NR^{22b}R^{22c}, wherein R^{22a} is hydrogen, alkyl, or optionally substituted aryl, and R^{22b} and R^{22c} are each independently hydrogen, alkyl, or optionally substituted aryl, or R^{22b} and R^{22c} taken together with the nitrogen to which they are attached form a 4- to 8-membered heterocyclo group. Non-limiting exemplary ureido groups include —NHC(C═O)NH₂ and —NHC(C═O)NHCH₃.

For the purpose of the present disclosure, the term “guanidino” as used by itself or as part of another group refers to a radical of the formula —NR^{25a}C(═NR²⁶)NR^{25b}R^{25c} wherein R^{25a}, R^{25b}, and R^{25c} are each independently hydrogen, alkyl, or optionally substituted aryl, and R²⁶ is hydrogen, alkyl, cyano, alkylsulfonyl, alkylcarbonyl, carboxamido, or sulfonamido. Non-limiting exemplary guanidino groups include —NHC(C═NH)NH₂, —NHC(C═NCN)NH₂, —NHC(C═NH)NHCH₃, and the like.

For the purpose of the present disclosure, the term “(heterocyclo)alkyl” as used by itself or as part of another group refers to an alkyl group substituted with one, two, or three optionally substituted heterocyclo groups. In one embodiment, the (heterocyclo)alkyl is a (C₁₋₄)alkyl substituted with one optionally substituted heterocyclo group. Non-limiting exemplary (heterocyclo)alkyl groups include:

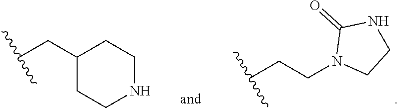 [SMILES: *CC1CCNCC1 ; *CCN1CCNC1=O]

For the purpose of the present disclosure, the term “(heteroaryl)alkyl” as used by itself or as part of another group refers to an alkyl group substituted with one, two, or three optionally substituted heteroaryl groups. In one embodiment, the (heteroaryl)alkyl group is a (C₁₋₄)alkyl substituted with one optionally substituted heteroaryl group. Non-limiting exemplary (heteroaryl)alkyl groups include:

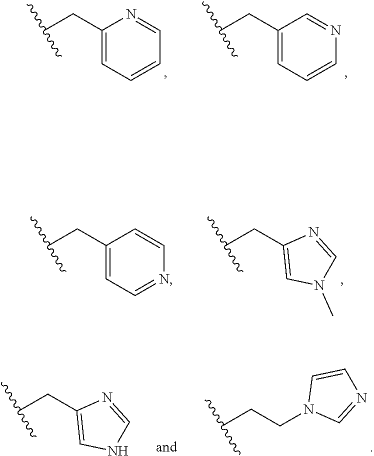

The present disclosure encompasses any of the compounds disclosed herein which are isotopically-labelled (i.e., radiolabeled) by having one or more atoms replaced by an atom having a different atomic mass or mass number. Examples of isotopes that can be incorporated into the disclosed compounds include isotopes of hydrogen, carbon, nitrogen, oxygen, phosphorus, fluorine and chlorine, such as ²H, ³H, ¹¹C, ¹³C, ¹⁴C, ¹⁵N, ¹⁸O, ¹⁷O, ³¹P, ³²P, ³⁵S, ¹⁸F, and ³⁶Cl, respectively, e.g., ³H, ¹¹C, and ¹⁴C. Isotopically-labeled compounds can be prepared by methods known in the art.

Some of the compounds disclosed herein may contain one or more asymmetric centers and may thus give rise to enantiomers, diastereomers, and other stereoisomeric forms. The present disclosure is meant to encompass the use of all such possible forms, as well as their racemic and resolved forms and mixtures thereof. The individual enantiomers can be separated according to methods known in the art in view of the present disclosure. When the compounds described herein contain olefinic double bonds or other centers of geometric asymmetry, and unless specified otherwise, it is intended that they include both E and Z geometric isomers. All tautomers are intended to be encompassed by the present disclosure as well.

As used herein, the term “stereoisomers” is a general term for all isomers of individual molecules that differ only in the orientation of their atoms in space. It includes enantiomers and isomers of compounds with more than one chiral center that are not mirror images of one another (diastereomers).

The term “chiral center” refers to a carbon atom to which four different groups are attached.

The terms “enantiomer” and “enantiomeric” refer to a molecule that cannot be superimposed on its mirror image and hence is optically active wherein the enantiomer rotates the plane of polarized light in one direction and its mirror image compound rotates the plane of polarized light in the opposite direction.

The term “racemic” refers to a mixture of equal parts of enantiomers and which mixture is optically inactive.

The term “about,” as used herein in connection with a measured quantity, refers to the normal variations in that measured quantity, as expected by the skilled artisan making the measurement and exercising a level of care commensurate with the objective of measurement and the precision of the measuring equipment.

### DETAILED DESCRIPTION

Disclosed herein are polyolefin compositions and articles that incorporate additives for improving flame-retardancy. In particular, flame-retardant systems are disclosed for use in thick cross section polyolefin (e.g., polypropylene, polyethylene, and co-polymers thereof) articles, such as building materials. The disclosed flame-retardant systems further allow for lower levels of flame-retardant additives in the polypropylene than commercial flame-retardant systems while still exhibiting high flame-retardancy.

Thick cross section articles are any articles that have minimum dimensions or minimum thicknesses that are greater than 1 mm (e.g., non-thin film articles). Thick cross section articles may also include multi-layered articles that have an overall thickness greater than 1 mm (e.g., several thin film articles layered onto each other or laminated together.

Thick cross section polyolefin articles produced from the disclosed compositions may be utilized to produce flame-retardant building materials, such as extruded or injection molding building cladding/siding, exterior building fascia (e.g., soffit, shingles, shutters), decking and railing, transportation or warehouse pallets, pipes, and membranes (e.g., roofing, geomembranes). In certain embodiments, the building materials may be formed from various polymers, including a polyolefin substrate and one or more of polystyrene, polyamides, polyesters, polycarbonates, epoxy resins, polyurethanes, and mixtures and blends of these materials. Certain other embodiments are directed to building materials formed from polyethylene, polypropylene, copolymers thereof, or mixtures thereof.

In certain embodiments, a flame-retardant polyolefin composition may include a polyolefin as a substrate material, as well as one or more additives. The additives may include, for example, one or more flame-retardant compounds, one or more hindered amine synergist compounds, one or more antioxidants and/or process stabilizers, one or more acid scavengers, one or more colorants, one or more fillers, one or more ultraviolet light absorbers, one or more nucleating agents or clarifying agents, and combinations thereof.

### Polyolefin Substrate

In certain embodiments, the polyolefin substrate includes, for example, polypropylene (PP), polyethylene (PE), and co-polymers thereof. The polyolefin substrate may have other polymers incorporated therein, including polystyrene, polyamide, polyester, polycarbonate, epoxy resins, polyurethane, and copolymers (e.g., random or block copolymers) or mixtures thereof. In certain embodiments, the polyolefin substrate includes linear low density polyethylene (LLDPE), low density polyethylene (LDPE), medium density polyethylene (MDPE), or high density polyethylene (HDPE). Certain embodiments of polymer mixtures include, for example, PP/HDPE, PP/LLDPE, and LLDPE/HDPE as well as ternary mixtures such as PP/HDPE/LLDPE. In certain embodiments, polymers can be linear or branched and can be formulated with or without crosslinking (e.g., chemical crosslinking).

In certain embodiments, blends of PP and PE may be optionally blended with a third polymer suitable to facilitate a level of compatibility, partial miscibility, or miscibility of components in the blend. Such materials are referred to as “interfacial tension reducing agents” or “compatibilizers”.

In certain embodiments, polymers may be crosslinked to introduce long chain branches (LCB) off of a polypropylene main chain, resulting in higher melt strength and extensibility and lower melt flow than is presently commercially available in polypropylene grades.

In certain embodiments that utilize polypropylene, compositions may contain an additive that promotes higher level of crystallinity formed in the polymer than otherwise exists upon melt converting into shaped articles. Such additives are referred to as “nucleating agents”.

Polyolefins can be prepared by various methods including, for example, radical polymerization (normally under high pressure and at elevated temperature) and catalytic polymerization (e.g., using a catalyst that normally contains one or more than one metal of groups IVb, Vb, VIb, or VIII). Such metals may form metal complexes that usually have one or more than one ligand, typically oxides, halides, alcoholates, esters, ethers, amines, alkyls, alkenyls, and/or aryls that may be either π- or σ-coordinated. Such metal complexes may be in the free form or fixed on substrates, typically on activated magnesium chloride, titanium(III) chloride, alumina, or silicon oxide. Catalysts may be soluble or insoluble in the polymerization medium. Catalysts can be used by themselves in the polymerization or further activators may be used, typically metal alkyls, metal hydrides, metal alkyl halides, metal alkyl oxides, or metal alkyloxanes, with the metals being elements of groups Ia, IIa, and/or IIIa. The activators may be modified conveniently with further ester, ether, amine, or silyl ether groups. These catalyst systems are usually termed “Phillips”, “Standard Oil Indiana”, “Ziegler(-Natta)”, “TNZ”, “metallocene”, or “single site catalysts”.

In certain embodiments that utilize polypropylene, the polypropylene is a polypropylene random copolymer, alternating or segmented copolymer, or block copolymer containing one or more comonomers selected from ethylene, 1-propene, C₄-C₂₀-α-olefin, vinylcyclohexane, vinylcyclohexene, C₄-C₂₀-alkandiene, C₅-C₁₂-cycloalkandiene, and norbornene derivatives, with a total mole amount of propylene and the comonomer(s) being 100%. Examples of suitable C₄-C₂₀-α-olefins include, but are not limited to, 1-butene, 1-pentene, 1-hexene, 1-heptene, 1-octene, 1-nonene, 1-decene, 1-undecene, 1-dodecene, 1-tetradecene, 1-hexadecene, 1-octadecene, 1-eicosene, and 4-methyl-1-pentene. Examples of suitable C₄-C₂₀-alkandienes include, but are not limited to, hexadiene and octadiene. Examples of suitable C₅-C₁₂-cycloalkandienes include, but are not limited to, cyclopentadiene, cyclohexadiene, and cyclooctadiene. Examples of suitable norbornene derivatives include, but are not limited to, 5-ethylidene-2-norbornene, dicyclopentadiene, and methylene-dimethylene-hexahydronaphthalene.

Polypropylene copolymers also include long chain branched polypropylene copolymer. In some embodiments, a propylene/ethylene copolymer contains, for example, 50 wt % to 99.9 wt %, 80 wt % to 99.9 wt %, or 90 wt % to 99.9 wt % propylene.

In certain embodiments, the polyolefin polymer forming the substrate is selected from polypropylene, polyethylene, and copolymers or mixtures thereof. The substrate may include additional polymers incorporated therein, including, but not limited to, polystyrene, polyamide, polyester, polycarbonate, epoxy resins, polyurethane, or copolymers or mixtures thereof. In certain embodiments, a total amount of the other polymers incorporated in the polyolefin substrate is less than 15 wt %, less than 20 wt %, less than 25 wt %, less than 30 wt %, less than 35 wt %, less than 40 wt %, less than 45 wt %, less than 50 wt %, less than 55 wt %, less than 60 wt %, less than 65 wt %, less than 70 wt %, less than 75 wt %, less than 80 wt %, or less than 85 wt % of a total weight of the polyolefin substrate.

In certain embodiments, a propylene copolymer in which the comonomer is a C₉-C₂₀-α-olefin (e.g., 1-nonene, 1-decene, 1-undecene, 1-dodecene, 1-tetradecene, 1-hexadecene, 1-octadecene or 1-eicosene), a C₉-C₂₀alkandiene, a C₉-C₁₂cycloalkandiene, or a norbornene derivative (e.g., 5-ethylidene-2-norbornene or methylene-dimethylene-hexahydronaphthalene) contain may contain at least 90 mol %, 90 mol % to 99.9 mol %, or 90 mol % to 99 mol % of propylene.

In certain embodiments, a propylene copolymer in which the comonomer is a C₄—C-α-olefin (e.g., 1-butene, 1-pentene, 1-hexene, 1-heptene, 1-octene, or 4-methyl-1-pentene), vinylcyclohexane, vinylcyclohexene, C₄-C₈-alkandiene, or C₅-C₈cycloalkandiene may contain at least 80 mol %, 80 mol % to 99.9 mol %, or 80 mol % to 99 mol % propylene.

Further embodiments of the polyolefin substrate include propylene/isobutylene copolymer, propylene/butadiene copolymer, propylene/cycloolefin copolymer, terpolymers of propylene with ethylene and a diene (e.g., hexadiene, dicyclopentadiene, or ethylidene-norbornene), propylene/1-olefin copolymers (e.g., where the 1-olefin is generated in situ), and propylene/carbon monoxide copolymers.

### Flame-Retardant Compounds

In certain embodiments, one or more flame-retardant compounds may be incorporated as additives into the polyolefin substrate.

Phosphorus containing flame-retardants may include phosphazene flame-retardants, which are disclosed for example in EP1104766, JP07292233, DE19828541, DE1988536, JP11263885, U.S. Pat. Nos. 4,079,035, 4,107,108, 4,108,805, and 6,265,599. Non-halogenated phosphorus-based flame-retardants are compounds that include phosphorus, such as triphenyl phosphates, phosphate esters, phosphonium derivatives, phosphonates, phosphoric acid esters, and phosphate esters, and those described in U.S. Pat. No. 7,786,199. Phosphorus-based (organophosphorus) flame-retardants are usually composed of a phosphate core to which is bonded alkyl (generally straight chain) or aryl (aromatic ring) groups. Examples include red phosphorus, inorganic phosphates, insoluble ammonium phosphate, ammonium polyphosphate, ammonium urea polyphosphate, ammonium orthophosphate, ammonium carbonate phosphate, ammonium urea phosphate, diammonium phosphate, ammonium melamine phosphate, diethylenediamine polyphosphate, dicyandiamide polyphosphate, polyphosphate, urea phosphate, melamine pyrophosphate, melamine orthophosphate, melamine salt of dimethyl methyl phosphonate, melamine salt of dimethyl hydrogen phosphite, ammonium salt of boron-polyphosphate, urea salt of dimethyl methyl phosphonate, organophosphates, phosphonates and phosphine oxide. Phosphate esters include, for example, trialkyl derivatives, such as triethyl phosphate, tris(2-ethylhexyl)phosphate, trioctyl phosphate, triaryl derivatives, such as triphenyl phosphate, cresyl diphenyl phosphate and tricresyl phosphate and aryl-alkyl derivatives, such as 2-ethylhexyl-diphenyl phosphate and dimethyl-aryl phosphates and octylphenyl phosphate, and ethylene diamine phosphates.

Other examples of phosphorus-based flame-retardants include methylamine boron-phosphate, cyanuramide phosphate, magnesium phosphate, ethanolamine dimethyl phosphate, cyclic phosphonate ester, trialkyl phosphonates, potassium ammonium phosphate, cyanuramide phosphate, aniline phosphate, trimethylphosphoramide, tris(1-aziridinyl)phosphine oxide, bis(5,5-dimethyl-2-thiono-1,3,2-dioxaphosphorinamyl)oxide, dimethylphosphono-N-hydroxymethyl-3-propionamide, tris(2-butoxyethyl)phosphate, tetrakis(hydroxymethyl)phosphonium salts, such as tetrakis(hydroxymethyl)phosphonium chloride and tetrakis(hydroxymethyl)phosphonium sulfate, n-hydroxymethyl-3-(dimethylphosphono)-propionamide, a melamine salt of boron-polyphosphate, an ammonium salt of boron-polyphosphate, triphenyl phosphite, ammonium dimethyl phosphate, melamine orthophosphate, ammonium urea phosphate, ammonium melamine phosphate, a melamine salt of dimethyl methyl phosphonate, a melamine salt of dimethyl hydrogen phosphite.

Metal hydroxide flame-retardants include inorganic hydroxides, such as aluminum hydroxide, magnesium hydroxide, alumina trihydrate (ATH) and hydroxycarbonate.

Melamine based flame-retardants are a family of non-halogenated flame-retardants that include three chemical groups: (a) melamine (2,4,6-triamino-1,3,5 triazine); (b) melamine derivatives (including salts with organic or inorganic acids, such as boric acid, cyanuric acid, phosphoric acid or pyro/poly-phosphoric acid); and (c) melamine homologues. Melamine derivatives include, for example, melamine cyanurate (a salt of melamine and cyanuric acid), melamine-mono-phosphate (a salt of melamine and phosphoric acid), melamine pyrophosphate and melamine polyphosphate. Melamine homologues include melam (1,3,5-triazin-2,4,6-triamine-n-(4,6-diamino-1,3,5-triazine-2-yl), melem (2,5,8-triamino 1,3,4,6,7,9,9b-heptaazaphenalene) and melon (poly[8-amino-1,3,4,6,7,9,9b-heptaazaphenalene-2,5-diyl).

Melamine based flame-retardants also include melamine compound/polyol condensates. For example, as disclosed in U.S. patent application Ser. No. 10/539,097 (published as WO 2004/055029) and U.S. Patent Pub. No. 2010/152376, where the polyol is a linear, branched or cyclic trihydric, tetrahydric, pentahydric or hexahydric alcohol or a linear or cyclic C₄-C₆ aldose or C₄-C₆ ketose and where the melamine compound is melamine phosphate, melamine pyrophosphate or melamine polyphosphate. In some embodiments, the polyol is pentaerythritol or dipentaerythritol. In some embodiments, the melamine compound is melamine phosphate. The molar ratio of melamine compound to the polyol is, in some embodiments, from about 1:1 to about 4:1. The condensate may further have incorporated therein a dendritic polymer substituted by hydroxy groups, for instance a dendritic polyester or dendritic polyamide. A dendritic polyester may be a product of an initiator compound selected from trimethyolpropane, pentaerythritol, ethoxylated pentaerythritol, and chain-extending dimethylpropionic acid. A dendritic polyamide is, in some embodiments, a polycondensate of a cyclic carboxylic acid anhydride and diisopropanolamine.

Borate flame-retardant compounds may include, for example, zinc borate, borax (sodium borate), ammonium borate, and calcium borate. Zinc borate is a boron based flame-retardant having the chemical composition xZnO_{y}B₂O₃.zH₂O. Zinc borate can be used alone, or in conjunction with other chemical compounds, such as alumina trihydrate, magnesium hydroxide or red phosphorus. It acts through zinc halide or zinc oxyhalide, which accelerate the decomposition of halogen sources and promote char formation.

Examples of other metal containing flame-retardant substances, which can be employed alone or in combination with other flame-retardant substances, include, but are not limited to, magnesium oxide, magnesium chloride, talcum, alumina hydrate, zinc oxide, alumina trihydrate, alumina magnesium, calcium silicate, sodium silicate, zeolite, sodium carbonate, calcium carbonate, ammonium molybdate, iron oxide, copper oxide, zinc phosphate, zinc chloride, clay, sodium dihydrogen phosphate, tin, molybdenum, and zinc.

In certain embodiments, the additives may include one or more flame-retardant compounds. The flame-retardant compound may include one or more organophosphorus compounds selected from phosphonate esters, phosphate esters, and combinations thereof.

In certain embodiments, the organophosphorus compound is a phosphonate ester having a formula of:

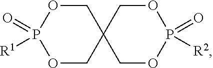

where R¹ and R² are independently selected from alkyl, optionally substituted alkyl, benzyl, optionally substituted benzyl, phenyl, optionally substituted phenyl, naphthyl, and optionally substituted naphthyl. In certain embodiments, both R¹ and R² are methyl (which is known commercially as AFLAMMIT® PCO 960 available from THOR).

In certain embodiments, the organophosphorus compound is a phosphate ester having a formula of:

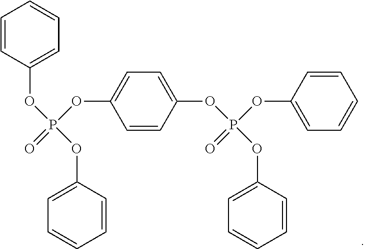 [SMILES: O=P(Oc1ccccc1)(Oc1ccccc1)Oc1ccc(OP(=O)(Oc2ccccc2)Oc2ccccc2)cc1]

In certain embodiments, the organophosphorus compound is a phosphonate ester having a formula of:

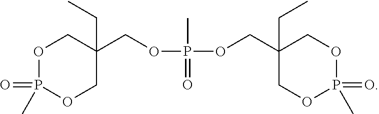 [SMILES: CCC1(COP(C)(=O)OCC2(CC)COP(C)(=O)OC2)COP(C)(=O)OC1]

In certain embodiments, the organophosphorus compound is a phosphonate ester having a formula of:

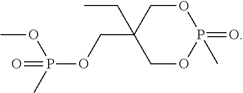 [SMILES: CCC1(COP(C)(=O)OC)COP(C)(=O)OC1]

In certain embodiments, the organophosphorus compound is a phosphate ester having a formula of:

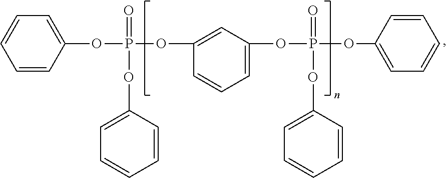

where n is an integer from 1 to 7.

In certain embodiments, the organophosphorus compound is a phosphate ester having a formula of:

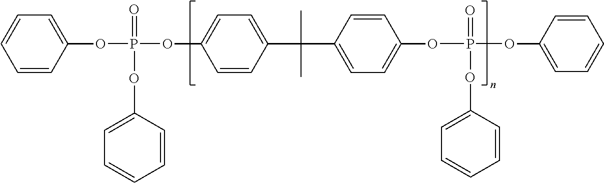

where n is 1 or 2.

In certain embodiments, the organophosphorus compound is a phosphate ester having a formula of:

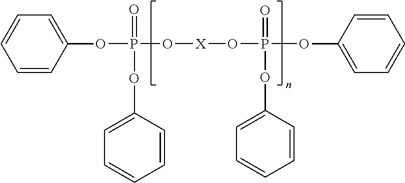

where X is divalent arylene, and n is 1 or 2.

In certain embodiments, the organophosphorus compound is a phosphate ester having a formula of:

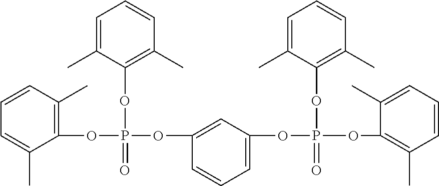 [SMILES: Cc1cccc(C)c1OP(=O)(Oc1cccc(OP(=O)(Oc2c(C)cccc2C)Oc2c(C)cccc2C)c1)Oc1c(C)cccc1C]

In certain embodiments, other suitable organophosphorus compounds may be used.

In certain embodiments, the one or more flame-retardant compounds (e.g., organophosphorus compounds) are present in an amount from 1 wt % to 70 wt %, 1 wt % to 60 wt %, 1 wt % to 50 wt %, 1 wt % to 40 wt %, 1 wt % to 30 wt %, 1 wt % to 20 wt %, 1 wt % to 10 wt %, 2 wt % to 9 wt %, 3 wt % to 6 wt %, 2 wt % to 5 wt %, or 1 wt % to 4 wt % based on a weight of the polyolefin substrate. For example, the one or more flame-retardant compounds may be present in an amount of about 1 wt %, about 2 wt %, about 3 wt %, about 4 wt %, about 5 wt %, about 6 wt %, about 7 wt %, about 8 wt %, about 9 wt %, or about 10 wt % based on the weight of the polyolefin substrate, as well as amounts in between the aforementioned amounts.

### Synergists

In certain embodiments, one or more synergists (e.g., light absorbers) may be incorporated as additives into the polyolefin substrate. Synergists may also be referred to as “stabilizers”. Certain synergist compounds described herein may also be utilized as flame-retardant compounds.

In certain embodiments, ultraviolet (UV) light absorbers include, for example, hydroxyphenylbenzotriazole, tris-aryl-s-triazine, hydroxyl-benzoate, and 2-hydroxybenzophenone ultraviolet light absorbers (UVAs), as well as cyanoacrylates such as those known by tradenames Uvinul® 3030, 3035, 3039.

Suitable hydroxyphenylbenzotriazole UVAs, for example, are disclosed in U.S. Pat. Nos. 3,004,896, 3,055,896, 3,072,585, 3,074,910, 3,189,615, 3,218,332, 3,230,194, 4,127,586, 4,226,763, 4,275,004, 4,278,589, 4,315,848, 4,347,180, 4,383,863, 4,675,352, 4,681,905, 4,853,471, 5,268,450, 5,278,314, 5,280,124, 5,319,091, 5,410,071, 5,436,349, 5,516,914, 5,554,760, 5,563,242, 5,574,166, 5,607,987, 5,977,219, and 6,166,218, and include, for example, 2-(2-hydroxy-5-methylphenyl)-2H-benzotriazole; 2-(3,5-di-t-butyl-2-hydroxyphenyl)-2H-benzotriazole; 2-(2-hydroxy-5-t-butylphenyl)-2H-benzotriazole; 2-(2-hydroxy-5-t-octylphenyl)-2H-benzotriazole; 5-chloro-2-(3,5-di-t-butyl-2-hydroxyphenyl)-2H-benzotriazole; 5-chloro-2-(3-t-butyl-2-hydroxy-5-methylphenyl)-2H-benzotriazole; 2-(3-sec-butyl-5-t-butyl-2-hydroxyphenyl)-2H-benzotriazole; 2-(2-hydroxy-4-octyloxyphenyl)-2H-benzotriazole; 2-(3,5-di-t-amyl-2-hydroxyphenyl)-2H-benzotriazole; 2-(3,5-bis-α-cumyl-2-hydroxyphenyl)-2H-benzotriazole; 2-(3-t-butyl-2-hydroxy-5-(2-(co-hydroxy-octa-(ethyleneoxy)carbonyl-ethyl)-phenyl)-2H-benzotriazole; 2-(3-dodecyl-2-hydroxy-5-methylphenyl)-2H-benzotriazole; 2-(3-t-butyl-2-hydroxy-5-(2-octyloxycarbonyl)ethylphenyl)-2H-benzotriazole; dodecylated 2-(2-hydroxy-5-methylphenyl)-2H-benzotriazole; 2-(3-t-butyl-2-hydroxy-5-(2-octyloxycarbonylethyl)phenyl)-5-chloro-2H-benzotriazole; 2-(3-tert-butyl-5-(2-(2-ethylhexyloxy)-carbonylethyl)-2-hydroxyphenyl)-5-chloro-2H-benzotriazole; 2-(3-t-butyl-2-hydroxy-5-(2-methoxycarbonylethyl)phenyl)-5-chloro-2H-benzotriazole; 2-(3-t-butyl-2-hydroxy-5-(2-methoxycarbonylethyl)phenyl)-2H-benzotriazole; 2-(3-t-butyl-5-(2-(2-ethylhexyloxy)carbonylethyl)-2-hydroxyphenyl)-2H-benzotriazole; 2-(3-t-butyl-2-hydroxy-5-(2-isooctyloxycarbonylethyl)phenyl-2H-benzotriazole; 2,2′-methylene-bis(4-t-octyl-(6-2H-benzotriazol-2-yl)phenol); 2-(2-hydroxy-3-α-cumyl-5-t-octylphenyl)-2H-benzotriazole; 2-(2-hydroxy-3-t-octyl-5-α-cumylphenyl)-2H-benzotriazole; 5-fluoro-2-(2-hydroxy-3,5-di-α-cumylphenyl)-2H-benzotriazole; 5-chloro-2-(2-hydroxy-3,5-di-α-cumylphenyl)-2H-benzotriazole; 5-chloro-2-(2-hydroxy-3-α-cumyl-5-t-octylphenyl)-2H-benzotriazole; 2-(3-t-butyl-2-hydroxy-5-(2-isooctyloxycarbonylethyl)phenyl)-5-chloro-2H-benzotriazole; 5-trifluoromethyl-2-(2-hydroxy-3-α-cumyl-5-t-octylphenyl)-2H-benzotriazole; 5-trifluoromethyl-2-(2-hydroxy-5-t-octylphenyl)-2H-benzotriazole; 5-trifluoromethyl-2-(2-hydroxy-3,5-di-t-octylphenyl)-2H-benzotriazole; methyl 3-(5-trifluoromethyl-2H-benzo-triazol-2-yl)-5-t-butyl-4-hydroxyhydrocinnamate; 5-butylsulfonyl-2-(2-hydroxy-3-α-cumyl-5-t-octylphenyl)-2H-benzotriazole; 5-trifluoromethyl-2-(2-hydroxy-3-α-cumyl-5-t-butyl-phenyl)-2H-benzotriazole; 5-trifluoromethyl-2-(2-hydroxy-3,5-di-t-butylphenyl)-2H-benzo-triazole; 5-trifluoromethyl-2-(2-hydroxy-3,5-di-α-cumylphenyl)-2H-benzotriazole; 5-butylsulfonyl-2-(2-hydroxy-3,5-di-t-butylphenyl)-2H-benzotriazole; and 5-phenylsulfonyl-2-(2-hydroxy-3,5-di-t-butylphenyl)-2H-benzotriazole.

Suitable tris-aryl-s-triazine UVAs, for example, are disclosed in U.S. Pat. Nos. 3,843,371, 4,619,956, 4,740,542, 5,096,489, 5,106,891, 5,298,067, 5,300,414, 5,354,794, 5,461,151, 5,476,937, 5,489,503, 5,543,518, 5,556,973, 5,597,854, 5,681,955, 5,726,309; 5,736,597, 5,942,626, 5,959,008, 5,998,116, 6,013,704, 6,060,543, 6,242,598, and 6,255,483, and include, for example, 4,6-bis-(2,4-dimethylphenyl)-2-(2-hydroxy-4-octyloxyphenyl)-s-triazine; CYASORB UV-1164; 4,6-bis-(2,4-dimethylphenyl)-2-(2,4-dihydroxyphenyl)-s-triazine; 2,4-bis(2,4-dihydroxyphenyl)-6-(4-chlorophenyl)-s-triazine; 2,4-bis[2-hydroxy-4-(2-hydroxyethoxy)phenyl]-6-(4-chlorophenyl)-s-triazine; 2,4-bis[2-hydroxy-4-(2-hydroxy-4-(2-hydroxyethoxy)phenyl]-6-(2,4-dimethylphenyl)-s-triazine; 2,4-bis[2-hydroxy-4-(2-hydroxy-ethoxy)phenyl]-6-(4-bromophenyl)-s-triazine; 2,4-bis[2-hydroxy-4-(2-acetoxyethoxy)-phenyl]-6-(4-chlorophenyl)-s-triazine; 2,4-bis(2,4-dihydroxyphenyl)-6-(2,4-dimethylphenyl)-s-triazine; 2,4-bis(4-biphenylyl)-6-(2-hydroxy-4-octyloxycarbonylethylideneoxyphenyl)-s-triazine; 2-phenyl-4-[2-hydroxy-4-(3-sec-butyloxy-2-hydroxypropyloxy)phenyl]-6-[2-hydroxy-4-(3-sec-amyloxy-2-hydroxypropyloxy)phenyl]-s-triazine; 2,4-bis(2,4-dimethyl-phenyl)-6-[2-hydroxy-4-(3-benzyloxy-2-hydroxypropyloxy)phenyl]-s-triazine; 2,4-bis(2-hydroxy-4-n-butyloxyphenyl)-6-(2,4-di-n-butyloxyphenyl)-s-triazine; 2,4-bis(2,4-dimethyl-phenyl)-6-[2-hydroxy-4-(3-nonyloxy*-2-hydroxypropyloxy)-5-α-cumylphenyl]-s-triazine (where * denotes a mixture of octyloxy, nonyloxy and decyloxy groups); methylenebis-{2,4-bis(2,4-dimethylphenyl)-6-[2-hydroxy-4-(3-butyloxy-2-hydroxypropoxy)phenyl]-s-triazine}; methylene bridged dimer mixture bridged in the 3:5′, 5:5′, and 3:3′ positions in a 5:4:1 ratio; 2,4,6-tris(2-hydroxy-4-isooctyloxycarbonylisopropylideneoxyphenyl)-s-triazine; 2,4-bis(2,4-dimethylphenyl)-6-(2-hydroxy-4-hexyloxy-5-α-cumylphenyl)-s-triazine; 2-(2,4,6-trimethyl-phenyl)-4,6-bis[2-hydroxy-4-(3-butyloxy-2-hydroxypropyloxy)phenyl]-s-triazine; 2,4,6-tris[2-hydroxy-4-(3-sec-butyloxy-2-hydroxypropyloxy)phenyl]-s-triazine; mixture of 4,6-bis-(2,4-dimethylphenyl)-2-(2-hydroxy-4-(3-dodecyloxy-2-hydroxypropoxy)-phenyl)-s-triazine and 4,6-bis-(2,4-dimethylphenyl)-2-(2-hydroxy-4-(3-tridecyloxy-2-hydroxypropoxy)-phenyl)-s-triazine; TINUVIN 400, 4,6-bis-(2,4-dimethylphenyl)-2-(2-hydroxy-4-(3-(2-ethylhexyloxy)-2-hydroxypropoxy)-phenyl)-s-triazine; and 4,6-diphenyl-2-(4-hexyloxy-2-hydroxyphenyl)-s-triazine.

Suitable hydroxybenzoate UV absorbers include, for example, esters of substituted and unsubstituted benzoic acids, such as 4-tert-butylphenyl salicylate, phenyl salicylate, octylphenyl salicylate, dibenzoyl resorcinol, bis(4-tert-butylbenzoyl) resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, and 2-methyl-4,6-di-tert-butylphenyl 3,5-di-tert-butyl-4-hydroxybenzoate.

2-hydroxybenzophenone UV absorbers include, for example, 4-hydroxy, 4-methoxy, 4-octyloxy, 4-decyloxy, 4-dodecyloxy, 4-benzyloxy, 4,2′,4′-trihydroxy, and 2′-hydroxy-4,4′-dimethoxy derivatives.

In certain embodiments, a UVA is included as an additive. The UVA may include one or more of 5-chloro-2-(3-t-butyl-2-hydroxy-5-methylphenyl)-2H-benzotriazole, 2-(3,5-bis-α-cumyl-2-hydroxyphenyl)-2H-benzotriazole, 4,6-diphenyl-2-(4-hexyloxy-2-hydroxyphenyl)-s-triazine, 4,6-bis-(2,4-dimethylphenyl)-2-(2-hydroxy-4-octyloxyphenyl)-s-triazine, 2,4-Di-tert-butylphenyl 3,5-di-tert-butyl-4-hydroxybenzoate, hexadecyl 3,5-di-tert-butyl-4-hydroxybenzoate, or 4-octyloxy-2-hydroxybenzophenone.

Certain UVAs are commercial formulations, including, for example TINUVIN 326, TINUVIN 234, TINUVIN 1577, TINUVIN 1600, CYASORB UV 1164, CYASORB THT, CYASORB UV 2908, and CHIMASSORB 81.

In certain embodiments, one or more UVAs are present in an amount from 0.01 wt % to 2.5 wt %, or 0.10 wt % to 1.5 wt % based on a weight of the polyolefin substrate. In certain embodiments, the one or more UVAs are present in an amount from 0.10 wt % to 0.95 wt %. For example, the one or more UVAs may be present in an amount of about 0.20 wt %, about 0.25 wt %, about 0.30 wt %, about 0.35 wt %, about 0.40 wt %, about 0.45 wt %, about 0.50 wt %, about 0.55 wt %, about 0.60 wt %, about 0.65 wt %, about 0.70 wt %, about 0.75 wt %, about 0.80 wt %, about 0.85 wt %, or about 0.90 wt % based on the weight of the polyolefin substrate, as well as amounts in between the aforementioned amounts.

In certain embodiments, one or more hindered amine light stabilizers (HALS) may be incorporated as additives into the polyolefin substrate. Suitable HALS, for example, are disclosed U.S. Pat. Nos. 5,004,770, 5,204,473, 5,096,950, 5,300,544, 5,112,890, 5,124,378, 5,145,893, 5,216,156, 5,844,026, 5,980,783, 6,046,304, 6,117,995, 6,271,377, 6,297,299, 6,392,041, 6,376,584, and 6,472,456.

Suitable HALS, for example, include 1-cyclohexyloxy-2,2,6,6-tetramethyl-4-octa-decylaminopiperidine; bis(2,2,6,6-tetramethylpiperidin-4-yl) sebacate; bis(1-acetoxy-2,2,6,6-tetramethylpiperidin-4-yl) sebacate; bis(1,2,2,6,6-pentamethylpiperidin-4-yl) sebacate; bis(1-cyclohexyloxy-2,2,6,6-tetramethylpiperidin-4-yl) sebacate; bis(1-octyloxy-2,2,6,6-tetra-methylpiperidin-4-yl) sebacate; bis(1-acyl-2,2,6,6-tetramethylpiperidin-4-yl) sebacate; bis(1,2,2,6,6-pentamethyl-4-piperidyl) n-butyl-3,5-di-tert-butyl-4-hydroxybenzylmalonate; 2,4-bis[(1-cyclohexyloxy-2,2,6,6-tetramethylpiperidin-4-yl)butylamino]-6-(2-hydroxyethyl-amino-s-triazine; bis(1-cyclohexyloxy-2,2,6,6-tetramethylpiperidin-4-yl) adipate; 2,4-bis[(1-cyclohexyloxy-2,2,6,6-piperidin-4-yl)butylamino]-6-chloro-s-triazine; 1-(2-hydroxy-2-methylpropoxy)-4-hydroxy-2,2,6,6-tetramethylpiperidine; 1-(2-hydroxy-2-methylpropoxy)-4-oxo-2,2,6,6-tetramethylpiperidine; 1-(2-hydroxy-2-methylpropoxy)-4-octadecanoyloxy-2,2,6,6-tetramethylpiperidine; bis(1-(2-hydroxy-2-methylpropoxy)-2,2,6,6-tetramethyl-piperidin-4-yl) sebacate; bis(1-(2-hydroxy-2-methylpropoxy)-2,2,6,6-tetramethylpiperidin-4-yl) adipate; 2,4-bis{N-[1-(2-hydroxy-2-methylpropoxy)-2,2,6,6-tetramethylpiperidin-4-yl]-N-butylamino}-6-(2-hydroxyethylamino)-s-triazine; 4-benzoyl-2,2,6,6-tetramethylpiperidine; di-(1,2,2,6,6-pentamethylpiperidin-4-yl) p-methoxybenzylidenemalonate; 2,2,6,6-tetramethylpiperidin-4-yl octadecanoate; bis(1-octyloxy-2,2,6,6-tetramethylpiperidyl) succinate; 1,2,2,6,6-pentamethyl-4-aminopiperidine; 2-undecyl-7,7,9,9-tetramethyl-1-oxa-3,8-diaza-4-oxo-spiro[4,5]decane; tris(2,2,6,6-tetramethyl-4-piperidyl) nitrilotriacetate; tris(2-hydroxy-3-(amino-(2,2,6,6-tetramethylpiperidin-4-yl)propyl) nitrilotriacetate; tetrakis-(2,2,6,6-tetramethyl-4-piperidyl)-1,2,3,4-butane-tetracarboxylate; tetrakis(1,2,2,6,6-pentamethyl-4-piperidyl)-1,2,3,4-butane-tetracarboxylate, 1,1′-(1,2-ethanediyl)-bis(3,3,5,5-tetramethylpiperazinone); 3-n-octyl-7,7,9,9-tetramethyl-1,3,8-triazaspiro[4.5]decan-2,4-dione; 8-acetyl-3-dodecyl-7,7,9,9-tetramethyl-1,3,8-triazaspiro[4.5]decane-2,4-dione; 3-dodecyl-1-(2,2,6,6-tetramethyl-4-piperidyl)pyrrolidin-2,5-dione; 3-dodecyl-1-(1,2,2,6,6-pentamethyl-4-piperidyl)pyrrolidine-2,5-dione; N,N′-bis-formyl-N,N′-bis(2,2,6,6-tetramethyl-4-piperidyl)hexamethylenediamine; reaction product of 2,4-bis[(1-cyclohexyloxy-2,2,6,6-piperidin-4-yl)butylamino]-6-chloro-s-triazine with N,N′-bis(3-aminopropyl)ethylenediamine); condensate of 1-(2-hydroxyethyl)-2,2,6,6-tetramethyl-4-hydroxypiperidine and succinic acid; condensate of N,N′-bis(2,2,6,6-tetramethyl-4-piperidyl)-hexamethylenediamine and 4-tert-octylamino-2,6-dichloro-1,3,5-triazine; condensate of N,N′-bis(2,2,6,6-tetramethyl-4-piperidyl)-hexamethylenediamine and 4-cyclohexylamino-2,6-dichloro-1,3,5-triazine; condensate of N,N′-bis-(2,2,6,6-tetramethyl-4-piperidyl)hexamethylenediamine and 4-morpholino-2,6-dichloro-1,3,5-triazine (CYASORB UV-3346), CYASORB UV-3529 (an N-methylated analog of CYASORB UV-3346); condensate of N,N′-bis-(1,2,2,6,6-pentamethyl-4-piperidyl)hexamethylenediamine and 4-morpholino-2,6-dichloro-1,3,5-triazine; condensate of 2-chloro-4,6-bis(4-n-butylamino-2,2,6,6-tetramethylpiperidyl)-1,3,5-triazine and 1,2-bis(3-aminopropylamino)ethane; condensate of 2-chloro-4,6-di-(4-n-butylamino-1,2,2,6,6-pentamethylpiperidyl)-1,3,5-triazine and 1,2-bis-(3-aminopropylamino)ethane; reaction product of 7,7,9,9-tetramethyl-2-cycloundecyl-1-oxa-3,8-diaza-4-oxospiro [4,5]decane and epichlorohydrin; poly[methyl,(3-oxy-(2,2,6,6-tetramethylpiperidin-4-yl)propyl)] siloxane; reaction product of maleic acid anhydride-C₁₈-C₂₂-α-olefin-copolymer with 2,2,6,6-tetramethyl-4-aminopiperidine; oligomeric condensate of 4,4′-hexamethylenebis(amino-2,2,6,6-tetramethylpiperidine) and 2,4-dichloro-6-[(2,2,6,6-tetramethylpiperidin-4-yl)butylamino]-s-triazine end-capped with 2-chloro-4,6-bis(dibutylamino)-s-triazine; oligomeric condensate of 4,4′-hexamethylenebis(amino-1,2,2,6,6-pentaamethylpiperidine) and 2,4-dichloro-6-[(1,2,2,6,6-pentaamethylpiperidin-4-yl)butylamino]-s-triazine end-capped with 2-chloro-4,6-bis(dibutylamino)-s-triazine; oligomeric condensate of 4,4′-hexamethylenebis(amino-1-propoxy-2,2,6,6-tetramethyl-piperidine) and 2,4-dichloro-6-[(1-propoxy-2,2,6,6-tetramethylpiperidin-4-yl)butylamino]-s-triazine end-capped with 2-chloro-4,6-bis(dibutylamino)-s-triazine; oligomeric condensate of 4,4′-hexamethylenebis(amino-1-acyloxy-2,2,6,6-tetramethylpiperidine) and 2,4-dichloro-6-[(1-acyloxy-2,2,6,6-tetramethylpiperidin-4-yl)butylamino]-s-triazine end-capped with 2-chloro-4,6-bis(dibutylamino)-s-triazine; reaction product obtained by reacting (2,2,6,6-tetra-methylpiperidin-4-yl)butylamine with product of reaction of 1,2-bis(3-amino-propylamino)ethane with cyanuric chloride; and binary or ternary combinations thereof.

Other suitable HALS include, for example, sterically hindered N—H, N-methyl, N-methoxy, N-propoxy, N-octyloxy, N-cyclohexyloxy, N-acyloxy, and N-(2-hydroxy-2-methylpropoxy) analogues of any of the aforementioned mentioned HALS compounds. For example, replacing an N—H hindered amine with an N-methyl hindered amine would be employing the N-methyl analogue in place of the N—H.

For illustrative purposes, some of the structures for the aforementioned HALS compounds are shown below.
bis(1-octyloxy-2,2,6,6-tetramethylpiperidin-4-yl) sebacate:

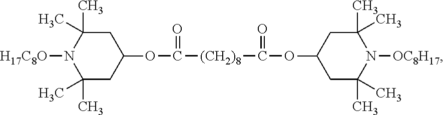

bis(1,2,2,6,6-pentamethyl-4-piperidyl) n-butyl-3,5-di-tert-butyl-4-hydroxybenzylmalonate:

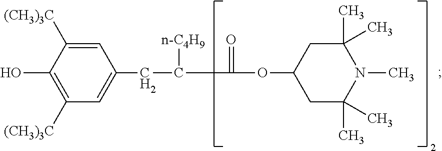

2,4-bis[(1-cyclohexyloxy-2,2,6,6-tetramethylpiperidin-4-yl)butylamino]-6-(2-hydroxyethyl-amino-s-triazine:

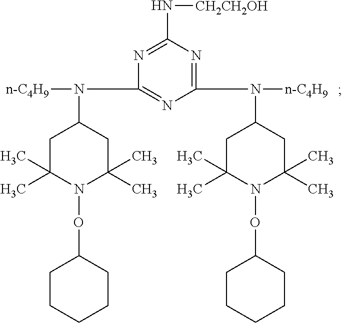

1-(2-hydroxy-2-methylpropoxy)-4-hydroxy-2,2,6,6-tetramethylpiperidine:

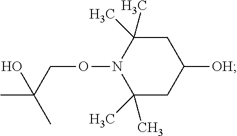 [SMILES: CC(C)(O)CON1C(C)(C)CC(O)CC1(C)C]

di-(1,2,2,6,6-pentamethylpiperidin-4-yl) p-methoxybenzylidenemalonate:

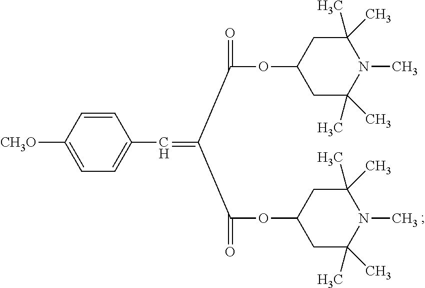

2-undecyl-7,7,9,9-tetramethyl-1-oxa-3,8-diaza-4-oxo-spiro[4,5]decane:

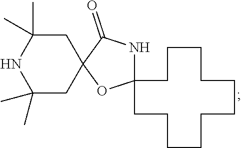 [SMILES: CC1(C)CC2(CC(C)(C)N1)OC1(CCCCCCCCCCC1)NC2=O]

tris(2-hydroxy-3-(amino-(2,2,6,6-tetramethylpiperidin-4-yl)propyl) nitrilotriacetate:

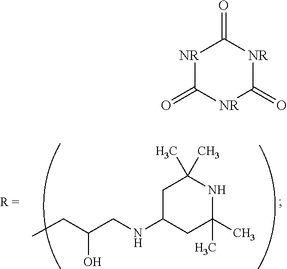

tetrakis(2,2,6,6-tetramethyl-4-piperidyl)-1,2,3,4-butane-tetracarboxylate:

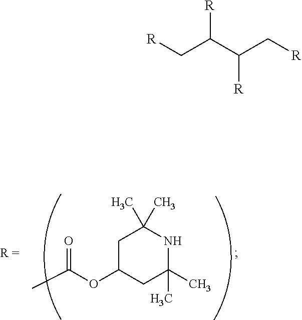

1,1′-(1,2-ethanediyl)-bis(3,3,5,5-tetramethylpiperazinone):

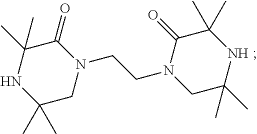

3-n-octyl-7,7,9,9-tetramethyl-1,3,8-triazaspiro[4.5]decan-2,4-dione:

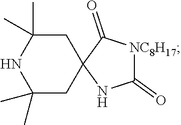

3-dodecyl-1-(2,2,6,6-tetramethyl-4-piperidyl)pyrrolidin-2,5-dione:

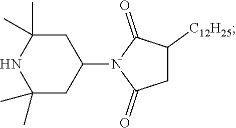

N,N′-bis-formyl-N,N′-bis(2,2,6,6-tetramethyl-4-piperidyl)hexamethylenediamine:

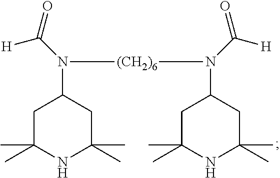

reaction product of 2,4-bis[(1-cyclohexyloxy-2,2,6,6-piperidin-4-yl)butylamino]-6-chloro-s-triazine with N,N′-bis(3-aminopropyl)ethylenediamine):

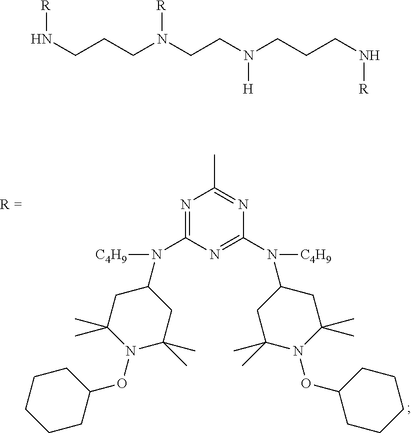

condensate of 1-(2-hydroxyethyl)-2,2,6,6-tetramethyl-4-hydroxypiperidine and succinic acid:

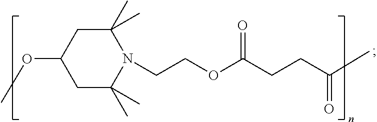

condensate of N,N′-bis(2,2,6,6-tetramethyl-4-piperidyl)-hexamethylenediamine and 4-tert-octylamino-2,6-dichloro-1,3,5-triazine:

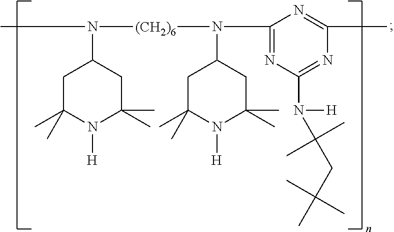

condensate of N,N′-bis-(2,2,6,6-tetramethyl-4-piperidyl)hexamethylenediamine and 4-morpholino-2,6-dichloro-1,3,5-triazine:

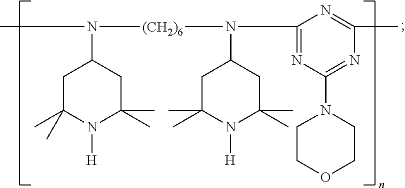

condensate of 2-chloro-4,6-di-(4-n-butylamino-1,2,2,6,6-pentamethylpiperidyl)-1,3,5-triazine and 1,2-bis-(3-aminopropylamino)ethane:

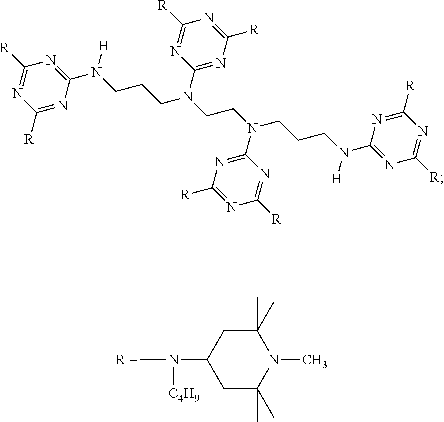

reaction product of 7,7,9,9-tetramethyl-2-cycloundecyl-1-oxa-3,8-diaza-4-oxospiro [4,5]decane and epichlorohydrin:

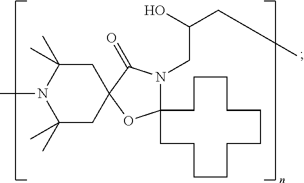

poly[methyl,(3-oxy-(2,2,6,6-tetramethylpiperidin-4-yl)propyl)] siloxane:

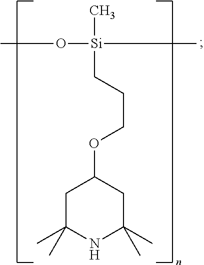

reaction product of maleic acid anhydride-C₁₈-C₂₂-□-olefin-copolymer with 2,2,6,6-tetramethyl-4-aminopiperidine:

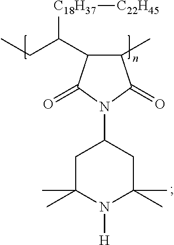

oligomeric condensate of 4,4′-hexamethylenebis(amino-2,2,6,6-tetramethylpiperidine) and 2,4-dichloro-6-[(2,2,6,6-tetramethylpiperidin-4-yl)butylamino]-s-triazine end-capped with 2-chloro-4,6-bis(dibutylamino)-s-triazine:

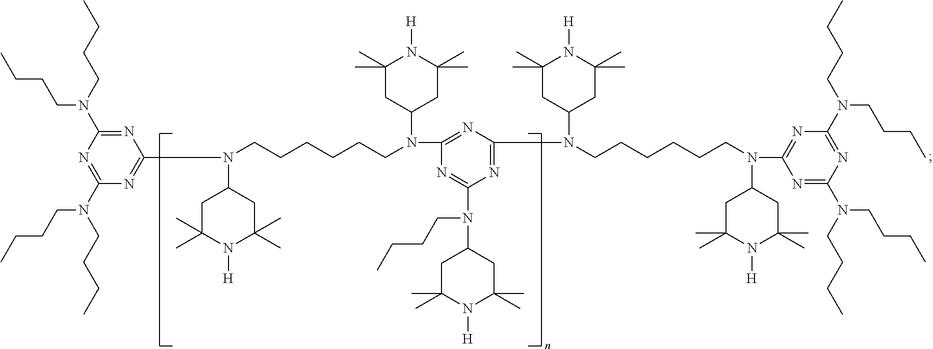

and reaction product obtained by reacting (2,2,6,6-tetramethylpiperidin-4-yl)butylamine with product of reaction of 1,2-bis(3-aminopropylamino)ethane with cyanuric chloride:

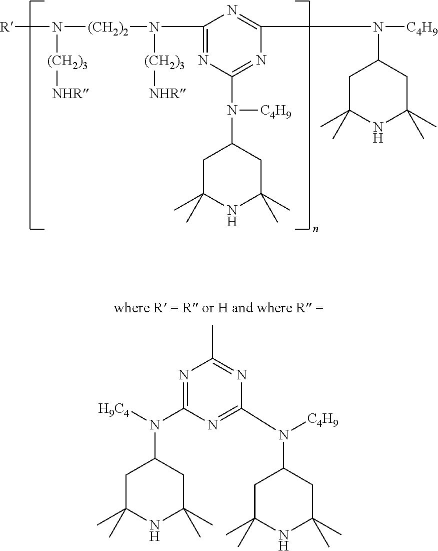

In certain embodiments, binary combinations of HALS may be included as additives. Such binary combinations include, for example, bis(2,2,6,6-tetramethylpiperidin-4-yl) sebacate and condensate of N,N′-bis(2,2,6,6-tetramethyl-4-piperidyl)-hexamethylenediamine and 4-tert-octylamino-2,6-dichloro-1,3,5-triazine; bis(2,2,6,6-tetramethylpiperidin-4-yl) sebacate and oligomeric compound condensate of 4,4′-hexamethylenebis(amino-2,2,6,6-tetra-methylpiperidine) and 2,4-dichloro-6-[(2,2,6,6-tetramethylpiperidin-4-yl)butylamino]-s-triazine end-capped with 2-chloro-4,6-bis(dibutylamino)-s-triazine; 2,2,6,6-tetramethylpiperidin-4-yl octadecanoate and oligomeric condensate of 4,4′-hexamethylene-bis(amino-2,2,6,6-tetramethylpiperidine) and 2,4-dichloro-6-[(2,2,6,6-tetramethylpiperidin-4-yl)butylamino]-s-triazine end-capped with 2-chloro-4,6-bis(dibutylamino)-s-triazine; and bis(2,2,6,6-tetramethylpiperidin-4-yl) sebacate and 2,2,6,6-tetramethylpiperidin-4-yl octadecanoate.

In certain embodiments, ternary combinations of HALS may be included as additives. Such ternary combinations include, for example bis(2,2,6,6-tetramethylpiperidin-4-yl) sebacate, 1-(2-hydroxy-2-methylpropoxy)-4-octadecanoyloxy-2,2,6,6-tetramethyl-piperidine, and oligomeric condensate of 4,4′-hexamethylenebis(amino-2,2,6,6-tetramethyl-piperidine) and 2,4-dichloro-6-[(2,2,6,6-tetramethylpiperidin-4-yl)butylamino]-s-triazine end-capped with 2-chloro-4,6-bis(dibutylamino)-s-triazine; 1-(2-hydroxy-2-methylpropoxy)-4-octadecanoyloxy-2,2,6,6-tetramethylpiperidine, 2,2,6,6-tetramethylpiperidin-4-yl octadecanoate, and oligomeric condensate of 4,4′-hexamethylenebis(amino-2,2,6,6-tetra-methylpiperidine) and 2,4-dichloro-6-[(2,2,6,6-tetramethylpiperidin-4-yl)butylamino]-s-triazine end-capped with 2-chloro-4,6-bis(dibutylamino)-s-triazine; and bis(2,2,6,6-tetramethylpiperidin-4-yl) sebacate, 1-(2-hydroxy-2-methylpropoxy)-4-octadecanoyloxy-2,2,6,6-tetramethylpiperidine, and condensate of N,N′-bis(2,2,6,6-tetramethyl-4-piperidyl)-hexamethylenediamine and 4-tert-octylamino-2,6-dichloro-1,3,5-triazine.

In certain embodiments, other binary or ternary combinations of any of the HALS compounds of the present disclosure may be utilized.

In certain embodiments, the additives may include one or more hindered amine compounds. In certain embodiments, the one or more hindered amine compounds includes an N-alkoxy hindered amine and/or an N-acyloxy hindered amine. Suitable N-alkoxy hindered amines are disclosed for example in U.S. app. No. 61/611,620 (published as WO2013/136285), U.S. Pat. Nos. 5,844,026, 6,271,377, 8,895,647, 8,765,848, 9,045,480 and U.S. Pub. No. 2014/336313. In one embodiments, the hindered amine compound has a formula of:

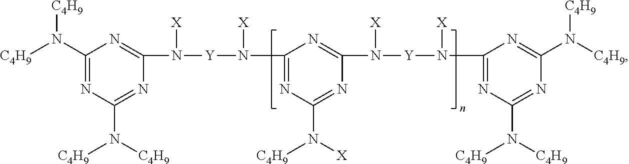

wherein X has a formula of:

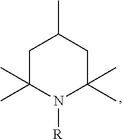

wherein Y is —(CH₂)₆—, wherein at least one R comprises alkoxy, and wherein n is an integer from 1 to 5. In certain embodiments, R is —OC₃H₇ (e.g., an N-alkoxy hindered amine). In such embodiments, the compound is referred to herein as “NOR-1”.

In certain embodiments, the hindered amine compound has a formula of:

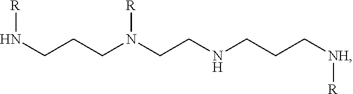

wherein R has a formula of:

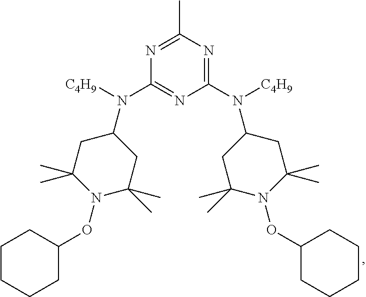

and is referred to herein as “NOR-2”.

In one embodiment, a hindered amine compound has a formula of:

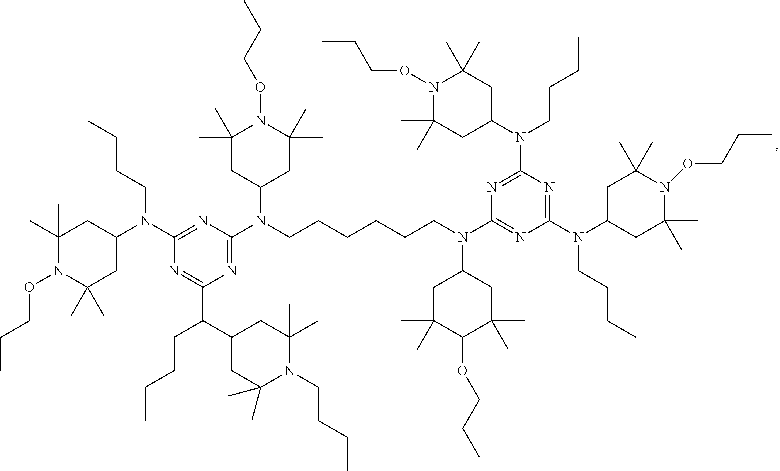 [SMILES: CCCCC(c1nc(N(CCCC)C2CC(C)(C)N(OCCC)C(C)(C)C2)nc(N(CCCCCCN(c2nc(N(CCCC)C3CC(C)(C)N(OCCC)C(C)(C)C3)nc(N(CCCC)C3CC(C)(C)N(OCCC)C(C)(C)C3)n2)C2CC(C)(C)C(OCCC)C(C)(C)C2)C2CC(C)(C)N(OCCC)C(C)(C)C2)n1)C1CC(C)(C)N(CCCC)C(C)(C)C1]

which is referred to herein as “NOR-3” and is described in U.S. patent application Ser. No. 14/444,495, filed Jul. 28, 2014, which is hereby incorporated by reference herein in its entirety.

In certain embodiments, the hindered amine compound has a formula of:

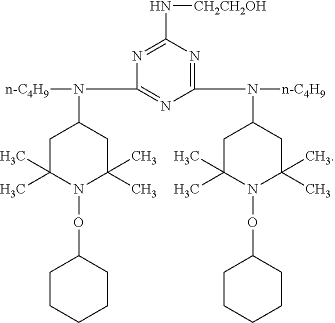

In certain embodiments, the hindered amine compound has a formula of:

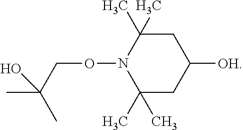 [SMILES: CC(C)(O)CON1C(C)(C)CC(O)CC1(C)C]

In certain embodiments, the hindered amine compound may be a compound containing one or more moieties of the following formula:

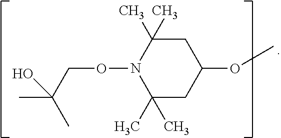

In certain embodiments, the hindered amine compound has a formula of

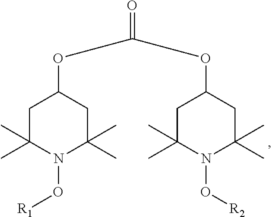

where R₁ and R₂ are independently selected from C₁-C₃₀ alkyl. In certain embodiments, R₁ and R₂ are both —(C₁₁H₂₃).

In certain embodiments, the hindered amine compound has a formula of:

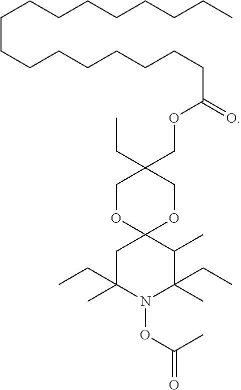 [SMILES: CCCCCCCCCCCCCCCCCC(=O)OCC1(CC)COC2(CC(C)(CC)N(OC(C)=O)C(C)(CC)C2C)OC1]

In certain embodiments, the hindered amine compound has a formula of:

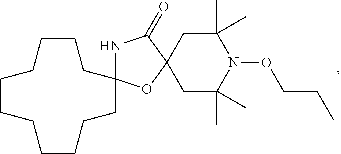 [SMILES: CCCON1C(C)(C)CC2(CC1(C)C)OC1(CCCCCCCCCCC1)NC2=O]

or may have a formula of other HALS compounds disclosed in U.S. Pat. No. 9,045,480, which is hereby incorporated by reference herein in its entirety.

In certain embodiments, the hindered amine compound has a formula of:

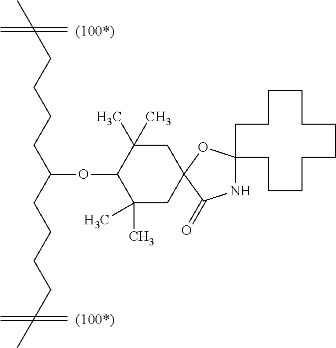

where (100*) denotes a backbone of a wax.

In certain embodiments, the one or more hindered amine compounds are present in an amount from 0.1 wt % to 3 wt %, 0.1 wt % to 1.9 wt %, 0.15 wt % to 1.5 wt %, 0.2 wt % to 1 wt %, or 0.2 to 0.5 wt % based on a weight of the polyolefin substrate. For example, the one or more hindered amine compounds may be present in an amount of about 0.10 wt %, about 0.20 wt %, about 0.30 wt %, about 0.40 wt %, about 0.50 wt %, about 0.60 wt %, about 0.70 wt %, about 0.80 wt %, about 0.90 wt %, about 1.00 wt %, about 1.10 wt %, about 1.20 wt %, about 1.30 wt %, or about 1.40 wt % based on the weight of the polyolefin substrate, as well as amounts in between the aforementioned amounts.

### Antioxidants

In certain embodiments, one or more antioxidants may be incorporated as additives into the polyolefin substrate. The antioxidants may include, but are not limited to, hydroxylamine stabilizers (e.g., dialkylhydroxylamine stabilizer), a combination of an organic phosphorus stabilizer and a hindered phenolic antioxidant, a combination of an organic phosphorus stabilizer and a dialkylhydroxylamine stabilizer, an amine oxide stabilizer, or a combination of an organic phosphorus stabilizer and an amine oxide stabilizer.

Organic phosphorus stabilizers include, for example, phosphite and phosphonite stabilizers such as triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl) phosphite, bis(2,4-di-α-cumylphenyl) pentaerythritol diphosphite, diisodecyl pentaerythritol diphosphite, bis(2,4-di-tert-butylphenyl) pentaerythritol diphosphite, bis(2,6-di-tert-butyl-4-methylphenyl) pentaerythritol diphosphite, bisisodecyloxy-pentaerythritol diphosphite, bis(2,4-di-tert-butyl-6-methylphenyl) pentaerythritol diphosphite, bis(2,4,6-tri-tert-butylphenyl) pentaerythritol diphosphite, tristearyl sorbitol triphosphite, tetrakis-(2,4-di-tert-butylphenyl) 4,4′-biphenylene-diphosphonite, 6-isooctyloxy-2,4,8,10-tetra-tert-butyl-dibenzo[d,f][1,3,2]dioxaphosphepin, 6-fluoro-2,4,8,10-tetra-tert-butyl-12-methyl-dibenzo[d,g][1,3,2]dioxaphosphocin, bis(2,4-di-tert-butyl-6-methylphenyl) methyl phosphite, bis(2,4-di-tert-butyl-6-methylphenyl) ethyl phosphite, 2,2′,2″-nitrilo[triethyltris(3,3′5,5′-tetra-tert-butyl-1,1′-biphenyl-2,2′-diyl) phosphite], bis(2,4-di-t-butylphenyl) octylphosphite, poly(4,4′-{2,2′-dimethyl-5,5′-di-t-butylphenylsulfide-}octylphosphite), poly(4,4′{-isopropylidenediphenol}-octylphosphite), poly(4,4′-{isopropylidenebis[2,6-dibromophenol]}-octylphosphite), and poly(4,4′-{2,2′-dimethyl-5,5′-di-t-butylphenylsulfide}-pentaerythritol diphosphite).

For illustrative purposes, some of the structures for the aforementioned antioxidants are shown below.
6-fluoro-2,4,8,10-tetra-tert-butyl-12-methyl-dibenzo[d,g][1,3,2]dioxaphosphocin:

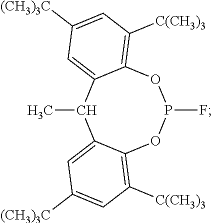 [SMILES: CC1c2cc(C(C)(C)C)cc(C(C)(C)C)c2OP(F)Oc2c1cc(C(C)(C)C)cc2C(C)(C)C]

2,2′,2″-nitrilo[triethyltris(3,3′5,5′-tetra-tert-butyl-1,1′-biphenyl-2,2′-diyl) phosphite]:

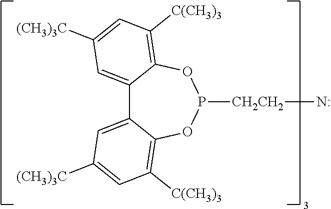

6-isooctyloxy-2,4,8,10-tetra-tert-butyl-dibenzo[d,f][1,3,2]dioxaphosphepin:

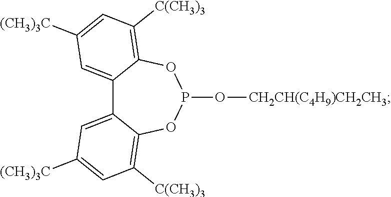

bis(2,4-di-tert-butylphenyl) pentaerythritol diphosphite:

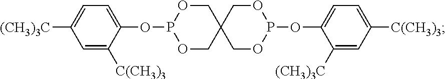 [SMILES: CC(C)(C)c1ccc(OP2OCC3(CO2)COP(Oc2ccc(C(C)(C)C)cc2C(C)(C)C)OC3)c(C(C)(C)C)c1]

bis(2,6-di-tert-butyl-4-methylphenyl) pentaerythritol diphosphite:

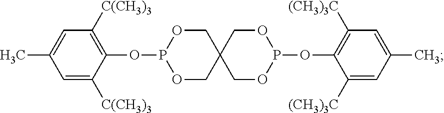 [SMILES: Cc1cc(C(C)(C)C)c(OP2OCC3(CO2)COP(Oc2c(C(C)(C)C)cc(C)cc2C(C)(C)C)OC3)c(C(C)(C)C)c1]

bis(2,4-di-tert-butyl-6-methylphenyl) ethyl phosphite:

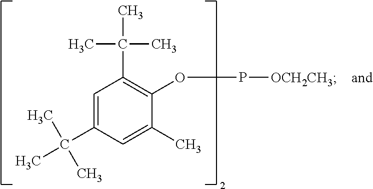

tetrakis-(2,4-di-tert-butylphenyl) 4,4′-biphenylene-diphosphonite:

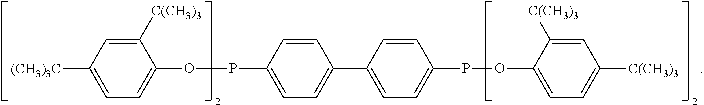

Other suitable antioxidants may have the following structures:

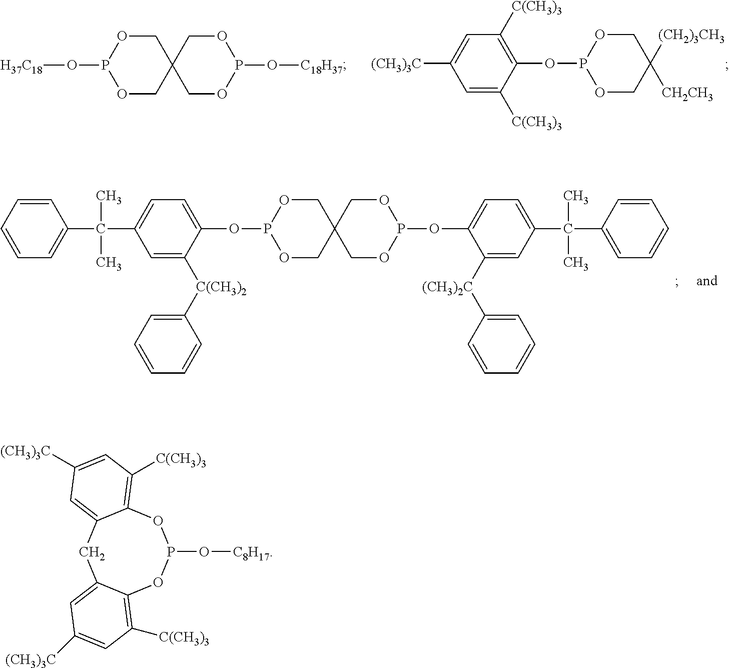

Hindered phenolic antioxidants include, for example, tris(3,5-di-tert-butyl-4-hydroxybenzyl) isocyanurate, 1,3,5-tris-(3,5-di-tert-butyl-4-hydroxybenzyl)-2,4,6-trimethylbenzene, calcium salt of the monoethyl ester of 3,5-di-tert-butyl-4-hydroxybenzylphosphonic acid, pentaerythritol tetrakis [3-(3,5-di-tert-butyl-4-hydroxyphenyl) propionate], and octadecyl 3-(3,5-di-tert-butyl-4-hydroxyphenyl) propionate. Vitamin E and vitamin E acetate antioxidants may also be used alone or in combination with other antioxidants.

In certain embodiments, the combination of an organic phosphorus stabilizer and a hindered phenolic antioxidant is tris(2,4-di-tert-butylphenyl) phosphite and pentaerythritol tetrakis [3-(3,5-di-tert-butyl-4-hydroxyphenyl) propionate] or octadecyl 3-(3,5-di-tert-butyl-4-hydroxyphenyl) propionate.

In certain embodiments, a weight:weight ratio of organic phosphorus stabilizer to hindered phenolic antioxidant is from about 9:1 to about 1:9, as well as with ratios in between, for instance about 8:1, about 7:1, about 6:1, about 5:1, about 4:1, about 3:1, about 2:1, about 1:1, about 1:2, about 1:3, about 1:4, about 1:5, about 1:6, about 1:7, or about 1:8 with ratios in between the aforementioned ratios.

Hydroxylamine stabilizers may include, for example, N,N-dibenzylhydroxylamine, N,N-diethylhydroxylamine, N,N-dioctylhydroxylamine, N,N-dilaurylhydroxylamine, N,N-didodecylhydroxylamine, N,N-ditetradecylhydroxylamine, N,N-dihexadecylhydroxylamine, N,N-dioctadecylhydroxylamine, N-hexadecyl-N-tetradecylhydroxylamine, N-hexadecyl-N-heptadecylhydroxylamine, N-hexadecyl-N-octadecylhydroxylamine, N-heptadecyl-N-octadecylhydroxylamine, N-methyl-N-octadecylhydroxylamine, and N,N-di(C₁₆-C₁₈alkyl)hydroxylamine.

Amine oxide stabilizers may include, for example, di(C₁₆-C₁₈) alkyl methyl amine oxide, a representative example being Genox® EP (Addivant).

In certain embodiments, a combination of an organic phosphorus stabilizer and a dialkylhydroxylamine is tris(2,4-di-tert-butylphenyl) phosphite and N,N-di(C₁₆-C₁₈alkyl)hydroxylamine. In certain embodiments, a combination of an organic phosphorus stabilizer and an amine oxide stabilizer is tris(2,4-di-tert-butylphenyl) phosphite and di(C₁₆-C₁₈)alkyl methyl amine oxide. The weight:weight ratios of these two combinations may be as above for the organic phosphorus/hindered phenolic antioxidant combination.

In certain embodiments, the additives may include one or more antioxidants. In certain embodiments, the one or more antioxidants include a combination of a first compound having a formula of:

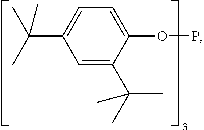

and a second compound having a formula of:

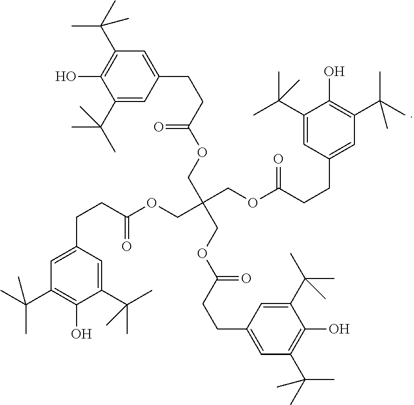 [SMILES: CC(C)(C)c1cc(CCC(=O)OCC(COC(=O)CCc2cc(C(C)(C)C)c(O)c(C(C)(C)C)c2)(COC(=O)CCc2cc(C(C)(C)C)c(O)c(C(C)(C)C)c2)COC(=O)CCc2cc(C(C)(C)C)c(O)c(C(C)(C)C)c2)cc(C(C)(C)C)c1O]

In some embodiments, the antioxidant may be a blend of the first and second compounds, available commercially as IRGANOX® B 225.

In certain embodiments, the one or more antioxidants are present in an amount from 0.01 wt % to 1 wt %, 0.01 wt % to 0.75 wt %, 0.01 wt % to 0.5 wt %, 0.01 wt % to 0.2 wt %, or 0.05 wt % to 1 wt % based on a weight of the polyolefin substrate. For example, the one or more antioxidants may be present in an amount of about 0.01 wt %, about 0.05 wt %, about 0.10 wt %, about 0.15 wt %, about 0.20 wt %, about 0.30 wt %, about 0.40 wt %, about 0.50 wt %, about 0.60 wt %, about 0.70 wt %, about 0.80 wt %, about 0.90 wt %, or about 1.00 wt % based on the weight of the polyolefin substrate, as well as amounts in between the aforementioned amounts.

### Colorants

In certain embodiments, one or more colorants may be incorporated as additives into the polyolefin substrate. The colorants may include, for example, organic pigments, inorganic pigments, and mixtures thereof. Some examples of colorants may be found in Pigment Handbook, T. C. Patton, Ed., Wiley-Interscience, New York, 1973. Any of commercial pigments used in polymer based products can be utilized in the present compositions such as metallic oxides (e.g., titanium dioxide, zinc oxide, aluminum oxide, and iron oxide) metal hydroxides, metal flakes (e.g., aluminum flakes), chromates (e.g., lead chromate), sulfides, sulfates, carbonates, carbon black, bismuth vanadate, silica, talc, china clay, phthalocyanine blues and greens, organo reds, organo maroons, pearlescent pigments, and other organic pigments. Chromate-free pigments, such as barium metaborate, zinc phosphate, aluminum triphosphate, and mixtures thereof, may also be used.

Other suitable pigments include C.I. Pigments, such as Black 12, Black 26, Black 28, Black 30, Blue 15.0, Blue 15.3 (G), Blue 15.3 (R), Blue 28, Blue 36, Blue 385, Brown 24, Brown 29, Brown 33, Brown 10P850, Green 7 (Y), Green 7 (B), Green 17, Green 26, Green 50, Violet 14, Violet 16, Yellow 1, Yellow 3, Yellow 12, Yellow 13, Yellow 14, Yellow 17, Yellow 62, Yellow 74, Yellow 83, Yellow 164, Yellow 53, Red 2, Red 3 (Y), Red 3 (B), Red 4, Red 48.1, Red 48.2, Red 48.3, Red 48.4, Red 52.2, Red 49.1, Red 53.1, Red 57.1 (Y), Red 57.1 (B), Red 112, Red 146, Red 170 (F5RK Type) Bluer, C.I. Pigment Orange 5, Pigment Orange 13, Pigment Orange 34, Pigment Orange 23 (R), and Pigment Orange 23 (B). Suitable organic pigments include Pigment Yellow 151, Pigment Yellow 154, Pigment Yellow 155, Pigment Red 8, Pigment Red 8, Pigment Red 49.2, Pigment Red 81, Pigment Red 169, Pigment Blue 1, Pigment Violet 1, Pigment Violet 3, Pigment Violet 27, Pigment Red 122, and Pigment Violet 19. Suitable inorganic pigments include Middle Chrome, Lemon Chrome, Primrose Chrome, Scarlet Chrome, and Zinc Chromate.

Suitable organic pigments may include, for example, phthalocyanines, perylenes, azo compounds, isoindolines, quinophthalones, diketopyrrolopyrroles, qyinacridones, dioxazines, and indanthrones. Blue pigments may include, for example, pigments of the indanthrone and copper phthalocyanine classes, for instance Pigment Blue 60, Pigment Blue 15:1, Pigment Blue 15:3, Pigment Blue 15:4, and Pigment Blue 15:6. Green pigments may include, for example, pigments of the copper phthalocyanine class, for instance Pigment Green 7 and Pigment Green 36. Magenta pigments may include, for example, pigments of the quinacridone class, for instance 2,9-dichloro quinacridone and Pigment Red 202. Red pigments may include, for example, pigments of the quinacridone class, for instance dimethyl quinacridone and Pigment Red 122, pigments of the perylene class, for instance Pigment Red 149, Pigment Red 178, and Pigment Red 179, or pigments of the diketopyrrolopyrrole class, for instance Pigment Red 254 and Pigment Red 264. Yellow pigments may include, for example, pigments of the pteridine, isoindolinone, and isoindoline classes, for instance Pigment Yellow 215, Pigment Yellow 110, and Pigment Yellow 139. Orange pigments may include, for example, pigments of the isoindolinone or diketopyrrolopyrrole classes, for instance Pigment Orange 61, Pigment Orange 71, and Pigment Orange 73. Violet pigments may include, for example, pigments of the quinacridone class, for instance Pigment Violet 19, or pigments of the dioxazine class, for instance Pigment Violet 23 and Pigment violet 37. In certain embodiments, mixtures of pigments may be utilized.

In certain embodiments, the one or more colorants may be present, in total, in an amount from 0.10 wt % to 3.0 wt %, or 0.20 wt % to 1.0 wt % based on a weight of the polyolefin substrate. For example, the one or more colorants may be present in an amount of about 0.3 wt %, about 0.4 wt %, about 0.5 wt %, about 0.6 wt %, about 0.7 wt %, about 0.8 wt %, or about 0.9 wt % based on the weight of the polyolefin substrate, as well as in amounts in between the aforementioned amounts.

### Fillers

In certain embodiments, one or more fillers may be incorporated as additives into the polyolefin substrate. Fillers act to improve the polymer mechanical properties, such as impact or tensile strength. Examples of fillers include, but are not limited to, metal hydrate such as aluminum trihydrate (ATH), metal oxide such as magnesium dihydroxide (MDH), and metal carbonate such as calcium carbonate. Other fillers useful for polyolefin compositions include wood chips, wood flour, wood flakes, wood fibers, sawdust, flax, jute, hemp, kenaf, rice hulls, abaca, natural cellulosic fibers, and combinations thereof. Fillers may be inorganic and include alkali or alkali earth metal carboxylates stearates or sulfates. For example, the inorganic fillers include talcs (magnesium silicates), mica, vermiculite, diatomite, perlite, calcium carbonate, dolomite, silica, magnesium hydroxide, zinc borate, wollastonite, fly ash, kaolin clay, mica, or various titanium dioxides including surface treated titanium dioxide. Fillers may also include organic or inorganic fibers, such as glass, polyester, polyamide, or polyaramid fibers. Suitable fillers for plastics are described in Wiley Encyclopedia of Polymer Science and Technology, Volume 10, “Fillers”, by A. H. Tsou, W. H. Waddell.

Loading levels of fillers may range, in certain embodiments, from 5 wt % to 70 wt %, 5 wt % to 60 wt %, 10 wt % to 50 wt %, or 15 wt % to 40 wt % based on a weight of the polyolefin substrate. For example, fillers may be present at about 20 wt %, about 25 wt %, about 30 wt %, or about 35 wt % based on the weight of the polyolefin substrate, as well as amounts in between the aforementioned amounts.

### Additional Additives

Further additives may also be present in the compositions disclosed herein, such as, antistats, antiscratch, slip agents, polymer processing aids, etc. (see Plastic Additives Handbook; 6^{th} Edition). Further additives include metal salts of fatty acids, for example, calcium, magnesium, zinc, or aluminum stearate. Further additives also include thiosynergists, for example dilauryl thiodipropionate or distearyl thiodipropionate. Further additives also include benzofuranone stabilizers, for example those disclosed in U.S. Pat. Nos. 4,325,863, 4,338,244, 5,175,312, 5,216,052, 5,252,643 5,369,159 5,356,966 5,367,008 5,428,177 or 5,428,162 or U.S. Patent App. Pub. No. 2012/0238677, including 3-[4-(2-acetoxyethoxy)phenyl]-5,7-di-tert-butyl-benzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butyl-benzofuran-2-one, 3-(3,5-dimethyl-4-pivaloyloxyphenyl)-5,7-di-tert-butyl-benzofuran-2-one, 3-(3,4-dimethylphenyl)-5,7-di-tert-butyl-benzofuran-2-one, 3-(2-acetyl-5-isooctylphenyl)-5-isooctylbenzofuran-2-one, and 3-(2,3-dimethylphenyl)-5,7-di-tert-butyl-benzofuran-2-one. Further additives also include compatibilizers or dispersing aids, for example, maleic anhydride grafted PE or PP, poly(ethylene-co-vinyl acetate), poly(ethylene-acrylic acid), etc. The further additives may be present from 0.1 wt % to 10 wt %, or 0.2 wt % to 5 wt % based on a weight of the polyolefin substrate.

In certain embodiments, the additives may include one or more additional additives, such as an acid scavenger. In certain embodiments, the acid scavenger is zinc stearate. In certain embodiments, the acid scavenger may be present, in total, in an amount from 0.1 wt % to 3.0 wt %, or 0.10 wt % to 2.0 wt % based on the weight of the polyolefin substrate.

### Embodiments of Polyolefin Articles

In preparing a polyolefin substrate having additives incorporated therein, any of components described herein and optional further additives can be premixed or added individually. In certain embodiments, additives can be added before, during, or after polymerization of olefins. In certain embodiments, additives can be incorporated into the substrate in pure form or encapsulated in waxes, oils or polymers. In certain embodiments, one or more additives are sprayed onto a polyolefin substrate, and may be used to dilute other additives or their melts so that the other additives can also be sprayed also together onto the polyolefin substrate. In certain embodiments, addition by spraying during deactivation of polymerization catalysts may be performed. In certain embodiments, steam may be used for deactivation.

In certain embodiments, a flame-retardant article includes a polyolefin substrate having additives incorporated therein. The additives include an organophosphorus compound including a phosphonate ester, a phosphate ester, or a combination thereof. The additives further include a synergist that includes an N-alkoxy hindered amine compound. In one embodiment, the article is an article of manufacture, such as a building material. The building material may be, for example, a shutter, a roofing shingle, building trim, a soffit, cladding, a pallet, a roofing cover, a floor tile, sheet flooring, a liner, a door, a door frame, a window frame, and a siding panel.

In certain embodiments, the building material is produced according to an injection molding or extrusion process. In certain embodiments, an article described herein may be molded or extruded into a monolithic, single layer article. In certain embodiments, the article may be a multilayer article formed, for example, via coextrusion, thermoforming, or lamination. A present multilayer article may contain at least one layer consisting of the present polyolefin composition. In certain embodiments, each layer of a multilayered article may be a thin film having a minimum physical dimension less than 1 mm. In certain embodiments, molding or extrusion is performed under melt conditions.

In certain embodiments, a minimum physical dimension of the article is greater than 1 mm, greater than 1.5 mm, or greater than 3 mm. The term “minimum physical dimension” refers to the smallest physical outward dimension of a solid object or a solid portion of an object. For example, a solid, rectangular article may have a length of 10 mm, a width of 5 mm, and a thickness of 3 mm. In such case, the thickness of 3 mm would be the minimum physical dimension of the article.

U.S. patents, U.S. published patent applications and U.S. patent applications discussed herein are each hereby incorporated by reference. The articles “a” and “an” are used herein to refer to one or to more than one (i.e., to at least one) of the grammatical object of the article. By way of example, “an N-alkoxy hindered amine” means one N-alkoxy hindered amine or more than one N-alkoxy hindered amine.

Any ranges cited herein are inclusive.

The terms “substantially” and “about” used throughout this specification are used to describe and account for small fluctuations. For example, they can refer to less than or equal to ±5%, such as less than or equal to ±2%, less than or equal to ±1%, less than or equal to ±0.5%, less than or equal to ±0.2%, less than or equal to ±0.1% or less than or equal to ±0.05%. All numeric values herein are modified by the term “about,” whether or not explicitly indicated. A value modified by the term “about” of course includes the specific value. For instance, “about 5.0” must include 5.0.

### Illustrative Examples

The following illustrative examples provide formulations for flame-retardant materials, in accordance with some of the embodiments described herein. The examples set forth to assist in understanding the invention and should not, of course, be construed as specifically limiting the invention described and claimed herein. Such variations of the invention, including the substitution of all equivalents now known or later developed, which would be within the purview of those skilled in the art, and changes in formulation or minor changes in experimental design, are to be considered to fall within the scope of the invention incorporated herein.

The following materials were used in one or more of the examples that follow:

Polypropylene was selected as a polyolefin substrate material. In some examples, the polypropylene used included high melt strength ExxonMobil 5341E1 polypropylene (“EM5341”), having a mass flow rate (MFR) of 0.83 g/10 min at 2.16 kg, 230° C., per the ExxonMobil datasheet. In other examples, the polypropylene used included Lyondell Basell Pro-fax 6301 polypropylene homopolymer (“PF6301”), having an MFR of 12.0 g/10 min at 2.16 kg, 230° C.

AFLAMMIT® PCO 960 (“PC0960”) was used as a flame-retardant compound.

Synergists used include NOR-1, NOR-2, and NOR-3, as described above.

IRGANOX® B 225 (IrgB), 0.01% dosage, was used as an antioxidant additive.

Zinc stearate (ZnSt), 0.5% dosage (grade SP, FAC1 Asia Pacific PTE Ltd.), was used as an acid scavenger additive.

Percentages shown are given wt % with respect to a total weight of the polyolefin substrate, unless otherwise indicated.

Unless otherwise indicated, extrusion conditions were as follows: 25 mm Coperion, 2 kg batches, 150 rpm screw speed, 10 lb/hr feed rate, temp. profile—(throat) 200, 220, 220, 220, 220, 220, 220° C.; Die melt temp—219-229° C.; melt pressure range of 300-420 psi.

Unless otherwise indicated, injection molding conditions were as follows: BOY model 50 to produce 0.125×5.0×0.5 inch UL-94 flame-retardant bars (“125 mil bars”); temp. profile—nozzle 450, 450, 450, 450° F.; mold temp. 60° F.

Chip impact testing was conducted according to ASTM D-256.

Ratings were given to different samples according to the UL-94 Test for Flammability of Plastic Materials for Parts in Devices and Appliances, 5^{th} Ed., Oct. 29, 1996, and/or an acceptably low flame spread index according to ASTM E-84 for the end use article. UL-94 VB test rating criteria are provided in Table 1.

TABLE 1
UL-94 VB test ratings

| Rating | Afterflame time | Burning drips | Burn to Clamp |
|---|---|---|---|
| V-0 | <10 s | no | no |
| V-1 | <30 s | no | no |
| V-2 | <30 s | yes | no |
| Fail (NR) | <30 s | | yes |
| Fail (NR) | >30 s | | no |

### Example 1

Polypropylene (EM5341), flame-retardant, synergist, and acid scavenger were blended together as powders and fed through a twin screw extruder for melt mixing. Subsequent injection of molding 125 mil thick bars was performed to produce samples for UL-94 VB evaluation and chip impact testing (ASTM D-4508). Compression molding of extruded granules produced 60 mil thick plaques and subsequent die-cutting of 60 mil dimension bars for UL-94 vertical burn evaluation. Results are summarized in Table 2.

As shown in Table 2, a beneficial UL94 VB rating of V-2 is achieved with as little as 5 wt % of a diphosphonate ester flame-retardant when 0.5 wt % of HALS synergist is used. It is noted that even 8 wt % of diphosphonate ester flame-retardant achieves no UL rating when used by itself. Furthermore, the most beneficial, highest performing V-0 rating was consistently achieved with 8 wt % of diphosphonate ester flame-retardant and 0.8 wt % HALS synergist (i.e., a 10:1 ratio).

TABLE 2
Vertical burn test results for Example 1 formulations.

| | | UL-94 results for | UL-94 results for |
|---|---|---|---|
| No. | Formulations | 125 mil bars | 60 mil bars |
| 1 | Blank PP | NR | NR |
| 2 | 3% PCO960 | NR | NR |
| 3 | 5% PCO960 | NR | NR |
| 4 | 8% PCO960 | NR | NR |
| 6 | 5% PCO960 | NR | V-2 |
| | 0.5% NOR-2 | | |
| 7 | 8% PCO960 | V-0 | V-2 |
| | 0.8% NOR-2 | | |
| 8 | 0.8% NOR-2 | NR | NR |

### Example 2

The samples of Example 2 were prepared in a similar manner as Example 1. As shown in Table 2, two different NOR HALS synergists are efficacious in enabling the diphosphonate ester to achieve UL-94 vertical burn ratings. NOR-1 appears to be more efficacious as a synergist in thicker 125 mil PP bars, allowing a lower loading of flame-retardant (5-6%) to reach a UL94 V-0 rating as compared to NOR-2 in this series.

TABLE 3
Vertical burn test results for Example 2 formulations

| | | UL-94 results for | UL-94 results for |
|---|---|---|---|
| No. | Formulations | 125 mil bars | 60 mil bars |
| 1 | Blank PP | NR | NR |
| 2 | 5% PCO960 | 4 of 5 bars | V-2 |
| | 0.5% NOR-2 | V-2 | |
| 3 | 6% PCO960 | 4 of 5 bars | V-2 |
| | 0.6% NOR-2 | V-0 | |
| 4 | 7% PCO960 | V-2 | V-2 |
| | 0.7% NOR-2 | | |
| 5 | 8% PCO960 | V-2 (1 of 5 bars | V-2 |
| | 0.8% NOR-2 | V-0) | |
| 6 | 5% PCO960 | 4 of 5 bars | V-2 |
| | 0.5% NOR-1 | V-0 | |
| 7 | 6% PCO960 | V-0 | V-2 |
| | 0.6% NOR-1 | | |
| 8 | 7% PCO960 | 4 of 5 bars | V-2 |
| | 0.7% NOR-1 | V-0 | |
| 9 | 8% PCO960 | V-0 | V-2 |
| | 0.8% NOR-1 | | |

### Example 3

UL-94 dimensional bars of Formulation #9 from Example 2 were subjected to accelerated light aging in an Atlas Ci-6000 Weather-Ometer® for one week to simulate outdoor exposure. The test settings included ASTM G155 cycle 1, with an irradiance of 0.35 W/m², and a black panel temperature of 63° C. Testing of bars after accelerated weathering yielded a UL94 V-0 rating, which was unchanged from the as-molded bars.

### Example 4

The combination of PC0960 with an alternative HALS synergist NOR-3 was evaluated similarly to procedures in Example 1. EM5141E1 HMS polypropylene was used as the substrate. A beneficial V-2 rating was obtained in 60 and 125 mil polypropylene bars.

TABLE 4
Vertical burn test results for Example 4 formulations

| | | UL-94 results for | UL-94 results for |
|---|---|---|---|
| No. | Formulations: | 125 mil bars | 60 mil bars |
| 1 | Blank PP | NR | NR |
| 2 | 5% PCO960 | V-2 | V-2 |
| | 0.5% NOR-3 | | |
| 3 | 6% PCO960 | V-2 | V-2 |
| | 0.6% NOR-3 | | |
| 4 | 7% PCO960 | 4 of 5 bars | V-2 |
| | 0.7% NOR-3 | V-0 | |
| 5 | 8% PCO960 | 4 of 5 bars | V-2 |
| | 0.8% NOR-3 | V-0 | |

### Example 5

A different, higher melt flow standard polypropylene (PF6301) was evaluated with flame-retardant combinations. As summarized in Table 5, UL 94 V-2 ratings were achieved in thick 60 mil and 125 mil bars with good retention of impact strength. Good retention of polymer impact strength was observed in the flame-retardant formulations.

TABLE 5
Vertical burn test and impact strength
results for Example 5 formulations

| | | | | Impact |
|---|---|---|---|---|
| | | UL-94 results | UL-94 results | Strength |
| No. | Formulations: | for 125 mil bars | for 60 mil bars | (ft-lb/in) |
| 1 | Blank PP | NR | NR | 4.9 |
| 2 | 5% PCO960 | NR | 4 of 5 bars | 4.1 |
| | 0.5% NOR-2 | | V-2 | |
| 3 | 8% PCO960 | V-2 | V-2 | 4.2 |
| | 0.8% NOR-2 | | | |

### Example 6

The combination of PC0960 with an alternative NOR HALS synergist in PP was evaluated. The diphosphonate ester was M102B from Meilalpo China. M102B is a reported blend of 95% of diphosphonate ester having a formula of:

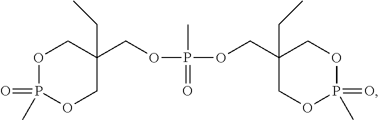 [SMILES: CCC1(COP(C)(=O)OCC2(CC)COP(C)(=O)OC2)COP(C)(=O)OC1]

with 5% of monostructural phosphonate ester having a formula of:

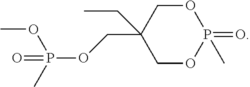 [SMILES: CCC1(COP(C)(=O)OC)COP(C)(=O)OC1]

44.6 grams of EM5341 polypropylene was mixed with 5.0 g of M102B and 0.4 g of NOR-1, and then charged to a Brabender mixing bowl. Theormulation was mixed at 230° C. at 30 rpm until the polypropylene fully melted to form a blend. The material was removed and immediately transferred to a compression mold where a 4″×6″×0.060″ polymer plaque was produced at 450° F. after 1.5 minutes of high pressure and 2 minutes cooling. UL94 bars were die cut from the plaque. A UL94 rating of V-2 was obtained for this formulation.

### Example 7

High density polyethylene (ExxonMobil HDPE 6908), synergist, flame-retardant, acid scavenger (ZnSt), and antioxidant (IrgB) were blended together as powders and fed through a twin screw extruder for melt mixing followed by pelletization. Subsequent injection molding (BOY 50M, temp profile (° C.): nozzle 230, 230, 230, 230) of HDPE pellets into 125 mil thick bars was performed to produce samples for UL-94 VB evaluation. Separately, compression molding of extruded granules (Coperion ZSK25 mm TSE, temp profile (° C.): throat 200, 210,210,210,210,210,210, die) produced 60 mil thick plaques and subsequent die-cutting of 60 mil dimension bars for UL-94 VB evaluation.

For both the 125 mil thick bars and 60 mil thick bars, a beneficial UL-94 VB rating of V-0 was achieved with 10% or 15% of PC0960 flame-retardant with 1% of NOR-1 synergist. In comparison, unstabilized polyethylene 60 or 125 mil bars burned to the holding clamp and the afterflame times exceeded 250 seconds, resulting in no UL-94 VB flammability rating.

### Example 8

Samples were prepared according to the weight percentages shown in Table 6. 125 mil bars were prepared by extrusion (25 mm Coperion, 2 kg batches, 150 rpm screw speed, 101b/hr feed rate, temp. profile (° C.)—200, 210, 210, 210, 210, 210, 210, die) and subsequent injection molding (temp. profile (° F.)—nozzle 450, 450, 450, 450 F). IrgB was used at 0.1% and ZnSt was used at 0.5% in all samples. The polyolefin used was EM5341. The results of Table 6 indicate that V-0 ratings were obtainable for NOR-1 synergist levels as low as 0.4% when 8% of PC0960 is used. V-0 ratings were obtainable for PC0960 levels as low as 5% when NOR-1 synergist level was 0.8%.

TABLE 6
Vertical burn test results for Example 8 formulations

| | | | UL-94 VB result |
|---|---|---|---|
| No. | PCO960 | NOR-1 | for 125 mil bars |
| 1 | 0.0% | 0.0% | NR |
| 2 | 0.0% | 0.8% | NR |
| 3 | 8.0% | 0.0% | V-2 |
| 4 | 5.0% | 0.8% | V-0 |
| 5 | 5.0% | 1.5% | V-2 (4/5 V-0) |
| 6 | 5.0% | 2.0% | V-0 |
| 7 | 8.0% | 0.4% | V-0 |
| 8 | 8.0% | 0.8% | V-0 |
| 9 | 8.0% | 1.2% | V-0 |
| 10 | 8.9% | 0.4% | V-0 |
| 11 | 8.9% | 0.8% | V-0 |
| 12 | 8.9% | 1.2% | V-0 |

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Reference throughout this specification to “an embodiment” or “one embodiment” means that a particular feature, structure, or characteristic described in connection with the embodiment is included in at least one embodiment. Thus, the appearances of the phrase “an embodiment” or “one embodiment” in various places throughout this specification are not necessarily all referring to the same embodiment.

The embodiments of the present disclosure have been described with reference to specific exemplary embodiments thereof. It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1. A flame-retardant article comprising a polyolefin substrate selected from the group consisting of polypropylene, polyethylene, and copolymers or mixtures thereof, and having additives incorporated therein, the additives comprising:
an organophosphorus compound comprising a phosphonate ester, a phosphate ester, or a combination thereof; and
a synergist comprising an N-alkoxy hindered amine,
wherein a performance rating of the article from a UL-94 vertical burn (VB) test is V-0 when the article is in a form of a 3.175 millimeter injection molded bar; and

2-3. (canceled)

4. The article of claim 1, wherein the organophosphorus compound is a phosphonate ester having a formula of: 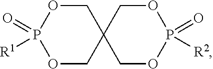
wherein R¹ and R² are independently selected from a group consisting of alkyl, optionally substituted alkyl, benzyl, optionally substituted benzyl, phenyl, optionally substituted phenyl, naphthyl, and optionally substituted naphthyl.

5. The article of claim 4, wherein both R¹ and R² are methyl.

6. The article of claim 1, wherein the organophosphorus compound is a phosphate ester having a formula of: 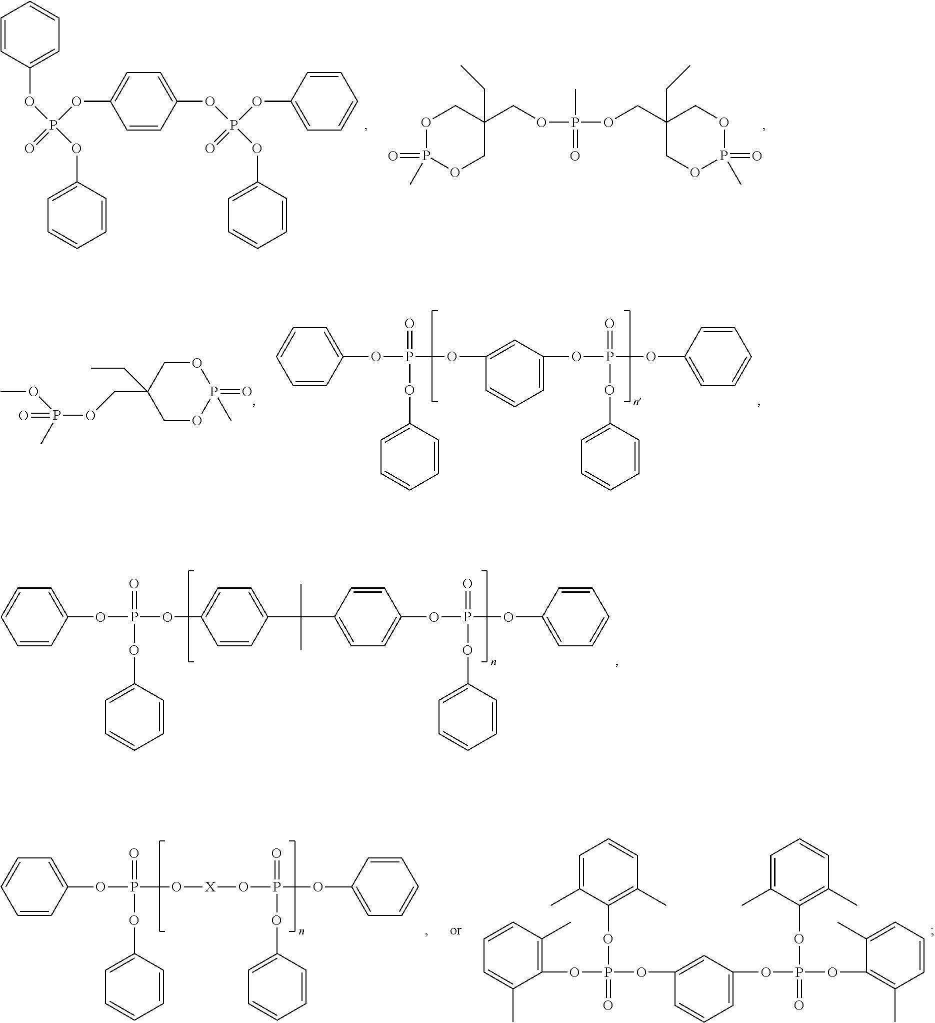
wherein: n′ is an integer from 1 to 7, n is 1 or 2, and X is divalent arylene.

7-13. (canceled)

14. The article of claim 1, wherein the N-alkoxy hindered amine is an N-cyclohexyloxy, N-propoxy, N-methoxy, or N-(2-methyl-2-hydroxypropoxy) hindered amine.

15. The article of claim 1, wherein the N-alkoxy hindered amine has a formula of: 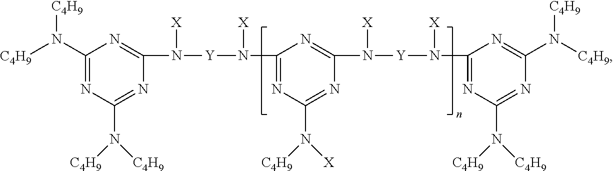
wherein X has a formula of: 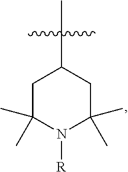
wherein Y is —(CH₂)₆—, wherein at least one R comprises alkoxy, and wherein n is an integer from 1 to 5.

16. The article of claim 15, wherein each R is —OC₃H₇.

17. The article of claim 1, wherein the N-alkoxy hindered amine has a formula of: 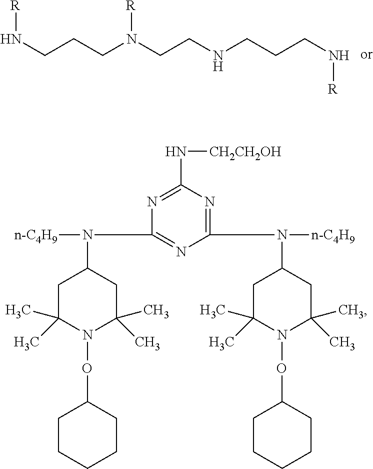
wherein R has a formula of:

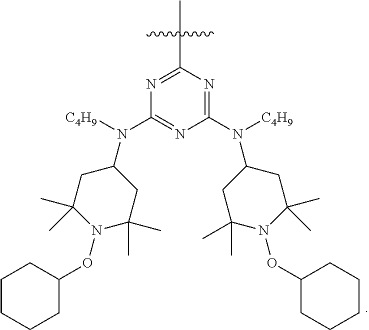

18-20. (canceled)

21. The article of claim 1, wherein the additives further comprise:
an antioxidant; and
an acid scavenger.

22. The article of claim 21, wherein the antioxidant comprises:
a first compound having a formula of: 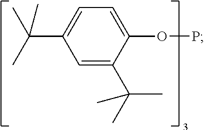
and
a second compound having a formula of:

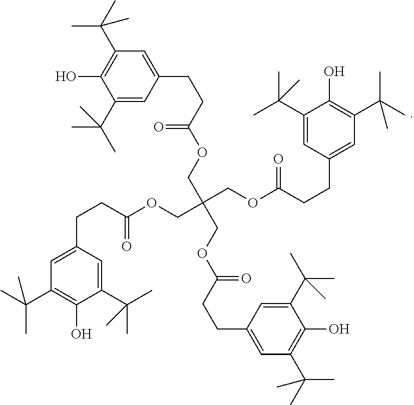 [SMILES: CC(C)(C)c1cc(CCC(=O)OCC(COC(=O)CCc2cc(C(C)(C)C)c(O)c(C(C)(C)C)c2)(COC(=O)CCc2cc(C(C)(C)C)c(O)c(C(C)(C)C)c2)COC(=O)CCc2cc(C(C)(C)C)c(O)c(C(C)(C)C)c2)cc(C(C)(C)C)c1O]

23-25. (canceled)

26. The article of claim 1, wherein the article is a building material selected from a group consisting of a shutter, a roofing shingle, building trim, a soffit, a roofing cover, a floor tile, sheet flooring, a liner, a door, a door frame, a window frame, and a siding panel.

27-29. (canceled)

30. The article of claim 1, wherein a minimum physical dimension of the article is greater than 3 mm.

31. A flame-retardant article comprising a polyolefin substrate having additives incorporated therein, the additives comprising;
an organophosphorus compound comprising a phosphonate ester, a phosphate ester, or a combination thereof; and
a synergist comprising an N-alkoxy hindered amine,
wherein the article is a building material selected from a group consisting of a shutter, a roofing shingle, building trim, a soffit, a roofing cover, a floor tile, sheet flooring, a liner, a door, a door frame, a window frame, and a siding panel; and wherein the building material was produced according to an injection molding or extrusion process; and wherein a performance rating of the article from a UL-94 VB test is V-0.

32-61. (canceled)

62. A flame-retardant composition comprising:
a polyolefin;
an antioxidant;
an acid scavenger;
a phosphonate ester having a formula of: 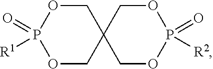
wherein R¹ and R² are independently selected from a group consisting of alkyl, optionally substituted alkyl, benzyl, optionally substituted benzyl, phenyl, optionally substituted phenyl, naphthyl, and optionally substituted naphthyl, and wherein the phosphonate ester is present in an amount from 1 wt % to 10 wt %; and
a synergist having a formula selected from: 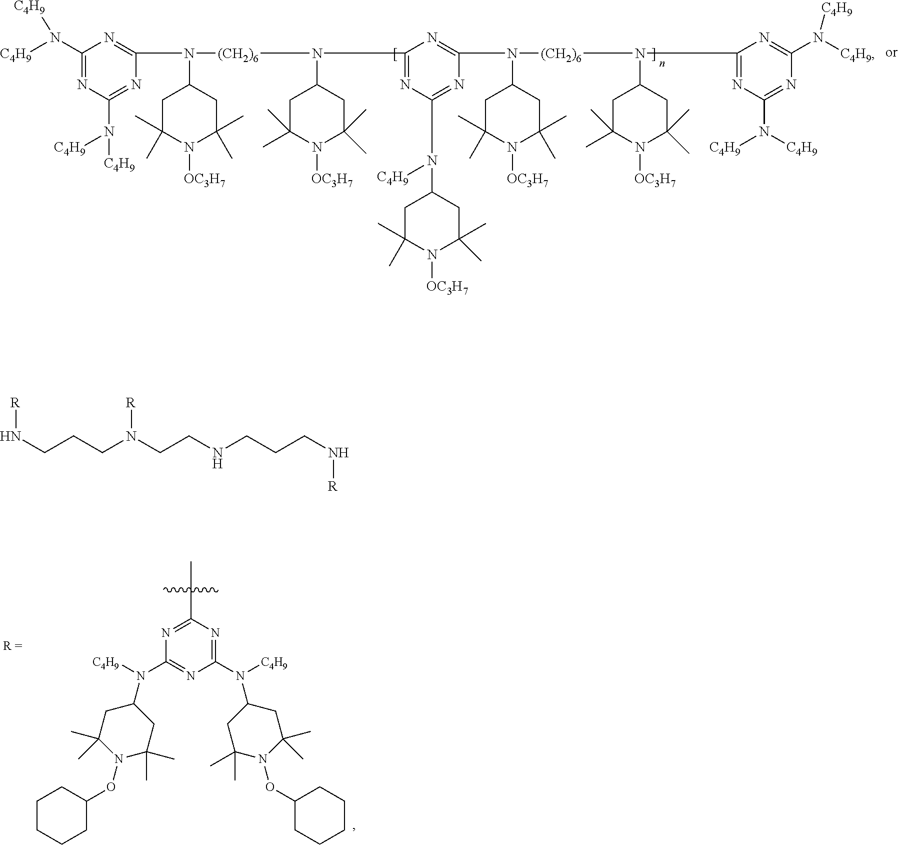
wherein n is an integer from 1 to 15, and wherein the synergist is present in an amount from 0.1 wt % to 3 wt %.

63. The composition of claim 62, wherein the polyolefin substrate comprises a polymer selected from a group consisting of polypropylene, polyethylene, and copolymers or mixtures thereof.

64. The article of claim 63, wherein the polyolefin has one or more additional polymers incorporated therein, the one or more additional polymers comprising polystyrene, polyamide, polyester, polycarbonate, epoxy resins, polyurethane, or copolymers or mixtures thereof.

65. The composition of claim 62, wherein the phosphonate ester is present in an amount from about 3 wt % to about 6 wt %, and the synergist is present in an amount from about 0.2 wt % to about 1 wt %.

66-67. (canceled)

68. The composition of claim 62, wherein the acid scavenger comprises zinc stearate, and wherein the zinc stearate is present in an amount from about 0.1 wt % to about 2 wt %.

69. The composition of claim 62, wherein the antioxidant comprises:
a first compound having a formula of: 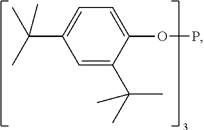
and
a second compound having a formula of: 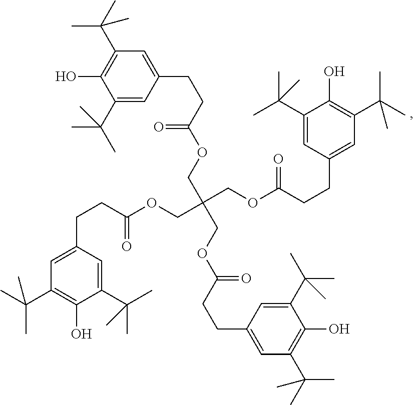 [SMILES: CC(C)(C)c1cc(CCC(=O)OCC(COC(=O)CCc2cc(C(C)(C)C)c(O)c(C(C)(C)C)c2)(COC(=O)CCc2cc(C(C)(C)C)c(O)c(C(C)(C)C)c2)COC(=O)CCc2cc(C(C)(C)C)c(O)c(C(C)(C)C)c2)cc(C(C)(C)C)c1O]
wherein the first and second compounds are present together in an amount from about 0.01 wt % to about 0.2 wt %.

70. The composition of claim 62, wherein a UL-94 VB test of the composition is V-0 for a 3.175 millimeter injection molded bar comprising the composition.
